(19) United States
(12) Patent Application Publication
(10) Pub. No.: US 2026/0287866 A1
(43) Pub. Date: Sep. 24, 2026

(54) REFRACTIVE AND HYBRID LENSES FOR COMPACT FOLDED TELE CAMERAS

(71) Applicant: Corephotonics Ltd., Tel Aviv (IL)

(72) Inventors: Michael Scherer, Tel Aviv (IL); Itamar Boral, Tel Aviv (IL); Gal Shabtay, Tel Aviv (IL); Nadav Goulinski, Tel Aviv (IL); Ephraim Goldenberg, Tel Aviv (IL)

(21) Appl. No.: 19/672,909

(22) Filed: May 11, 2026

Related U.S. Application Data
(63) Continuation of application No. 19/121,808, filed on Dec. 10, 2023.
(60) Provisional application No. 63/386,912, filed on Dec. 11, 2022.
(60) Provisional application No. 63/476,406, filed on Dec. 21, 2022.
(60) Provisional application No. 63/495,141, filed on Apr. 10, 2023.
(60) Provisional application No. 63/543,309, filed on Oct. 10, 2023.

(51) Int. Cl. G02B 13/02; G02B 13/00

(52) U.S. Cl. CPC G02B 13/02; G02B 13/0065

(57) ABSTRACT

Folded digital cameras for use in mobile devices such as smartphones and comprising a lens with N≥4 lens elements, an effective focal length (EFL) and a f-number f/#, an optical path folding elements (OPFE), and an image sensor with a sensor diagonal SD. Some of the lenses may be metalenses or include metalens elements. In some cameras, the lens is located at an object side of the OPFE, 8 mm<EFL<50 mm, SD/EFL>0.4, and f/#<2.75. In some cameras in which M≥1 of the lens elements are metalens elements and O=N−M of the lens elements are refractive lenses, 8 mm<EFL<40 mm and SD/EFL>0.3.

### CROSS REFERENCE TO RELATED APPLICATIONS

This is a continuation of U.S. patent application Ser. No. 19/121,808 filed 17 Apr. 2025 which was a 371 application from international patent application PCT/IB2023/062443 filed 10 Dec. 2023, and is related to and claims priority from U.S. Provisional Patent Applications 63/386,912 filed 11 Dec. 2022, 63/476,406 filed 21 Dec. 2022, 63/495,141 filed 10 Apr. 2023 and 63/543,309 filed 10 Oct. 2023, all of which are incorporated herein by reference in their entirety.

### FIELD

The presently disclosed subject matter is generally related to the field of digital cameras.

### Definitions

In this application and for optical and other properties mentioned throughout the description and figures, the following symbols and abbreviations are used, all for terms known in the art:

Total track length (TTL): the maximal distance, measured along an axis parallel to the optical axis of a lens, between a point of the front surface S₁ of a first lens element L₁ and an image sensor, when the system is focused to an infinity object distance.

Back focal length (BFL): the minimal distance, measured along an axis parallel to the optical axis of a lens, between a point of the rear surface S_{2N} of the last lens element L_{N} and an image sensor, when the system is focused to an infinity object distance.

Effective focal length (EFL): in a lens (assembly of lens elements L₁ to L_{N}), the distance between a rear principal point P′ and a rear focal point F′ of the lens.

f-number (f/#): the ratio of the EFL to an entrance pupil diameter (or “aperture diameter” or “DA”) of a lens.

### BACKGROUND

Multi-aperture cameras (or “multi-cameras”, of which a “dual-cameras” having two cameras is an example) are today's standard for portable handheld mobile devices (“mobile devices”, e.g. smartphones, tablets, headsets etc.). Multi-cameras are compact in size, i.e. they have a relatively low height (or thickness), width\ and length, which is beneficial for use in compact mobile devices. A multi-camera usually comprises a wide field-of-view (or “angle”) FOV_{W} camera (“Wide” camera or “W” camera), and at least one additional camera, e.g. with a narrower (than FOV_{W}) FOV (Telephoto or “Tele” camera with FOV_{T}), or with an ultra-wide field of view FOV_{UW} (wider than FOV_{W}, “UW” camera).

FIG. 1A shows schematically an example of a known folded Tele camera 100. Camera 100 comprises a lens 102, an optical path folding element (OPFE) 104 (e.g. a prism or a mirror) and an image sensor 106. OPFE 104 folds a first optical path (“OP1”) 108 to a second OP2 110. Light from a scene passes lens 102, is reflected at OPFE 104 and impinges on image sensor 106. Here and in the following, a “height” (e.g. a height H_{L} of lens 102 or a height H_{S} of image sensor 106, as shown) is measured along an axis parallel to OP1 108, a “length” (e.g. a length L_{L} of lens 102, as shown) is measured along an axis parallel to OP2 110. Lens 102 includes a plurality of N lens elements (here: N=4) numbered L₁-L_{N}. Lens 102 is located at an object side of the OPFE, has a lens optical axis (“OA”) parallel to OP1 108, and a lens height (or lens thickness) H_{L} as well as a lens length (or lens width) L_{L}. ΔLO marks a distance between lens 102 and OPFE 104. L_{OPFE} marks a length of OPFE 104 along the z-axis. OPFE 104 may be oriented at an angle of 45 degrees with respect to OP1 and OP2, so that for a height H_{OPFE} of OPFE 104 yields H_{OPFE}=L_{OPFE}. A TTL and a BFL of camera 100 are divided into TTL₁ and TTL₂ and BFL₁ and BFL₂ respectively. TTL₁ and BFL₁ are parallel to OP1 108, TTL₂ and BFL₂ are parallel to OP2 110. TTL=TTL₁+TTL₂ and BFL=BFL₁+BFL₂. An aperture of camera 100 is numbered 112 and has an aperture diameter (“DA”). Such a known folded Tele camera is for example disclosed in PCT/IB2022/055745, which is included herein in its entirety. In all examples disclosed herein, a f/# of a camera such as camera 100 is given by f/#=EFL/DA.

A theoretical limit for a length of a camera module including a camera such as camera 100 (“minimum module length” or “ML_{M}”) and a first height thereof (“minimum module height” or “MH_{M}”) as well as a second height thereof (“minimum shoulder height” or “MH_{S}”<MH_{M}) is shown. ML_{M}, MH_{S} and MH_{M} are defined by the smallest dimensions of the components included in camera 100. The camera module includes a housing 114. Housing 114 defines the size (or dimensions) of the camera module. The camera module has a module region 116 of height H_{M} and a shoulder region 118 of height H_{S}<H_{M}.

For estimating theoretical limits for minimum dimensions of a camera module that includes optical lens systems described herein, we introduce the following parameters and interdependencies. It is noted opposite to the “theoretical limits” defined above, parameter such as “module length”, “module height”, “shoulder height” etc. define dimensions of a camera module as defined by a housing such as housing 114.

ML_{M} and “Module Length” (“L_{M}”)
Minimum module length (“ML_{M}”) is the theoretical limit for a length of a camera module that includes all components of camera 100.
ML_{M}=Z_{Lens}−Z_{Sensor}, Z_{Lens} being the maximum z-value of lens 102 and Zₛₑₙₛₒᵣ being the minimum z-value of image sensor 106. In other words, measured along OP2 110, ML_{M} represents a largest distance from any part of lens 102 to any part of image sensor 106.
For achieving a realistic estimation for a camera module length (“L_{M}”), one may add for example a length of 3.5 mm to ML_{M}, i.e. L_{M}=ML_{M}+3.5 mm. The additional length accounts for a lens stroke that may be required for optical image stabilization (OIS) as well as for image sensor packaging, housing, etc. In other examples, one may add +5 mm, or +2.5 mm or even +2 mm.

### Minimum Module Region Length MRL_{M}

MRL_{M} is the theoretical module region length limit of module region 116 having height H_{M}. MRL_{M} is defined by lens 102 included in module region 116, i.e. MRL_{M}=L_{L}.
   Minimum Shoulder Region Length MRL_{S} and Shoulder Length (“L_{S}”)
MRL_{S} is the theoretical module region length limit of shoulder region 118 having height H_{S}<H_{M}. MRL_{S} is defined by image sensor 106 included in shoulder region 118.

$${MRL}_{S} = {ML}_{M} - {MRL}_{M} .$$

In general and for a given ML_{M}, from an industrial design point of view it may be beneficial to maximize MRL_{S} (minimize MRL_{M}), as it can minimize BL (FIG. 1B).
For achieving a realistic estimation for L_{S}, one may add for example a length of 2.5 mm to MRL_{S}, i.e. L_{S}=MRL_{S}+2.5 mm. In other examples, one may add +5 mm, or +2 mm or even +1.5 mm.
   MH_{M} and “Module Height” (“H_{M}”)
MH_{M} is the theoretical limit for a height of module region 116.
MH_{M} is given by the difference between the lowest y-values occupied by image sensor 106 and the highest y-value occupied by lens 102. In other words, measured along OP1 108, MH_{M} represents a largest distance from any part of lens 102 to any part of image sensor 106.
For achieving a realistic estimation for HM, one may add an additional height of 1.5 mm to MH_{M}, i.e. H_{M}=MH_{M}+1.5 mm. The additional length accounts for housing, lens cover etc. In other examples, one may add +3 mm, or +1 mm or even +0.5 mm.
   Minimum Shoulder Height (“MH_{S}”) and “Shoulder Height” (“H_{S}”)
MH_{S} is the theoretical limit for a height of shoulder region 118. In some examples, MH_{S} may be determined solely by a height H_{Sensor} of image sensor 106, i.e. MH_{S}=H_{Sensor}.
Image sensor 106 may have a width: height ratio of 4:3, so that a full sensor diagonal (SD) is given by SD=5/3·H_{Sensor}.
H_{S} is estimated by adding an additional height of, for example, 1.5 mm to MH_{S}, i.e. H_{S}=MH_{S}+1.5 mm. The additional height accounts for contacting sensor 106 as well as for housing. In other examples, one may add +3 mm, or +1 mm or even +0.5 mm.

FIG. 1B shows schematically a mobile device 120 (e.g. a smartphone) including known folded Tele camera 100 in a cross-sectional view. Aperture 112 of camera 100 is located at a rear (or “world-facing”) surface 122 and points towards a scene, a front (or “user-facing”) surface 124 opposite to surface 122 may e.g. include a screen (not shown). Mobile device 120 may include a processor such as an application processor (“AP”). The processor may be configured to process image data captured by a Wide camera, a Tele and/or an UW camera included in the mobile device. Mobile device 120 has a regular region 126 of thickness (“T”) and a camera bump region 128 that is elevated by a bump height B over regular region 126. Bump region 128 has a bump length (“BL”) and a bump thickness T+B. Module region 116 may be integrated into bump region 128, and shoulder region 118 may be integrated into regular region 126, as shown. For industrial design reasons, a small camera bump (i.e. a short BL) and a slim camera bump (i.e. a low B) are desired. Camera 100 is integrated in the bump region only partially, what allows a relatively short BL. In general and for slim mobile devices, it is beneficial to minimize MH_{M} and MH_{S}. Especially minimizing MH_{M} is of interest, as it allows minimizing B. For compact camera, also minimizing ML_{M} is beneficial. Especially minimizing MRL_{M} is of interest, as it allows minimizing BL. B_{Min} is a theoretical minimum for a height B of camera bump region 128, and given by B_{Min}=H_{M}−T.

FIG. 1C shows schematically an example of a folded Tele camera disclosed herein and numbered 130. Camera 130 comprises a lens 132 with a plurality of N lens elements (here N=4) numbered L₁-L₄, with L₁ being oriented towards an object side. Camera 130 further comprises an OPFE 134 that folds a first optical path OP1 138 to a second OP2 140 and an image sensor 136. The camera may be included in a housing 142, as shown. In camera 130, OP1 138 is substantially parallel to the y-axis and the lens OA. OP2 140 is oriented perpendicular to image sensor 136. OP2 140 forms an angle α with the z-axis, so to OP2 140 it is referred to as a “sloped OP”. OPFE 134 forms an angle β of B>45 degrees with the y-axis and an angle 90−β<45 degrees with the z-axis. As of OP 140's slope, BFL₂ and TTL₂ respectively have a component measured along the y-axis (“TTL2_{y}”, “BFL2_{y}”) and a component measured along the z-axis (“TTL2_{z}”, “BFL2_{z}”), so that BFL2=sqrt(BFL2_{y}²+BFL2_{z}²) and TTL2=sqrt (TTL2_{y}²+TTL2_{z}²). As of the sloped OP, sensor 136 forms an angle of 2×(β−45) with the y-axis.

Advantages of such a camera with sloped OP are:
1. Incorporation of large image sensors, e.g. 1/2.5″ or larger. Large image sensors are beneficial for capturing a relatively large amount of light.
2. Low f/#. Low f/# is beneficial for capturing a relatively large amount of light and for imaging with a relatively high spatial (or pixel) resolution.
3. A more compact module size, i.e. MH_{M} and ML_{M} can be smaller with respect to a camera with a non-sloped OP (assuming identical EFL, lens aperture and image sensor sizes for the cameras with sloped and non-sloped OP respectively).

FIG. 1D shows schematically another mobile device 150 with dimensions and components as described in FIG. 1B and FIG. 1C including folded Tele camera 130 in a cross-sectional view. Camera 130 is fully integrated into camera bump region 128. The lens elements of lens 132 may be carried by a lens barrel.

In other examples, a housing of a folded Tele camera such as folded Tele camera 130 may have (or may be divided into) a module region having a module region height H_{M} and a shoulder region having a shoulder region height H_{S}<H_{M}, as shown for folded Tele camera 100. Such a Tele camera may be included into a mobile device as shown for mobile device 120. I.e., a shoulder region may be included in a regular region of the mobile device and a module region may be included in a camera bump region of the mobile device.

An advantage of camera 100 and camera 130 is that for a given H_{M} (or a given bump thickness T+B), a relatively large aperture diameter (“DA”) can be achieved, what results in a relatively low f/#. This is because an optical power of lens 102 and lens 132 respectively concentrates the light before it impinges on OPFE 104 and OPFE 134 respectively. “Concentrating the light” means here that a first circle which is oriented perpendicular to the optical axis of the lens and includes all light rays that form an image at the image sensor, the first circle being located at an object side of the lens, is larger than a second circle which is oriented perpendicular to the optical axis of the lens and includes all light rays that form an image at the image sensor, the second circle being located at an image side of the lens and at an object side of the OPFE. H_{M} of camera 100 and camera 130 (and thus B) is limited by H_{L}, i.e. for decreasing H_{M}, H_{L} must be decreased.

It is known that including conventional diffractive lenses (CDLs) into “regular” (or “refractive”) lenses can decrease a lens height such as H_{L} significantly. The same holds for a weight of a lens. Regular lens means here a lens that includes a plurality of N refractive lens elements which are all made of glass and/or plastic. When introducing one or more CDLs or diffractive lenses into a regular lens, one speaks of a “hybrid” lens. For example, Canon describes the capabilities of CDLs in terms of chromatic aberration correction in a hybrid lens in the article “Research on multi-layer diffractive optical elements and their application to camera lenses” (T. Nakai and H. Ogawa, in Diffractive Optics and Micro-Optics, R. Magnusson, ed., Vol. 75 of OSA Trends in Optics and Photonics Series (Optica Publishing Group, 2002), paper DMA2.). Plastic and glass lenses exhibit a positive chromatic aberration, meaning that blue light is refracted stronger than red light. In contrast, CDLs exhibit a negative chromatic aberration, meaning that red light is refracted stronger than blue light. Combining these properties in a hybrid lens allows for an efficient and slim chromatic aberration correction, what allows a lower H_{L} while still supporting a given set of lens parameter such as EFL, TTL, f/# etc. As detailed above, in camera 100 a lower H_{L} allows for a lower H_{M} and thus a slimmer camera module. Recently, significant advances in the field of metalenses (“MLs”) were achieved, as detailed in the article “The advantages of metalenses over diffractive lenses”, J. Engelberg and U. Levy, in Nat Commun 11, 1991 (2020). By manufacturing specific nanostructures on a first surface of a substrate, a ML is formed on the first surface. That is, the ML is located only on the first side of the substrate. In a ML, a phase is induced via a response of light on the nanostructures. A ML is differentiated from a CDLby its smaller structure sizes. One speaks of a metalens if it includes sub-wavelength quasi-periodic structures, and of a CDL if it includes super-wavelength quasi-periodic structures. MLs share many properties of DOEs, namely the property of exhibiting negative chromatic aberration. Thus it is reasonable to assume that a H_{L} of a hybrid lens comprising refractive plastic (and/or glass) lenses and, in addition, one or more MLs, can be significantly lower than a H_{L} of a regular lens comprising only refractive lenses.

It would be beneficial to have slim regular lenses and hybrid lenses comprising plastic (and/or glass) lenses and one or more MLs that allow for slim mobile cameras. Such slim regular lenses and hybrid lenses are disclosed herein.

### SUMMARY

In various exemplary embodiments there is provided a camera, comprising: a lens having a lens optical axis OA, N≥4 lens elements Lᵢ, an effective focal length EFL, an aperture diameter DA, a f-number f/#, a total track length TTL and a back focal length BFL, each lens element has a respective focal length fᵢ, and a first lens element L₁ faces an object side and a last lens element L_{N} faces an image side; an image sensor having a full sensor diagonal SD; and an optical path folding element OPFE for providing a folded optical path between an object and the image sensor, wherein the camera is a folded digital camera, wherein the lens is located at an object side of the OPFE, wherein the EFL is in the range of 8 mm<EFL<50 mm, wherein SD/EFL>0.4, and wherein f/#<2.75.

In some examples, f/#<2.7. In some examples, f/#<2.6. In some examples, f/#<2.5.

In some examples, the OPFE is oriented at an angle β with respect to the lens OA, wherein 45<β≤65 degrees. In some examples, 45<β≤60 degrees. In some examples, 45<β≤55 degrees. In some examples, 46<β≤50 degrees.

In some examples, SD/EFL>0.5.

In some examples, the camera is included in a camera module having a module height H_{M}, wherein SD/H_{M}>0.7.

In some examples, the camera is included in a camera module having a module height H_{M}, wherein SD/H_{M}>0.75.

In some examples, N=4, and a power sequence of lens elements L₁-L₄ is plus-minus-plus-plus.

In some examples, each lens element Lᵢ has a lens element thickness Tᵢ and a smallest lens element semi-diameter (D/2)ᵢ, and a ratio of Tᵢ/(D/2)ᵢ<0.25 for each of L₂, L₃ and L₄. In some examples Tᵢ/(D/2)ᵢ<0.2 for each of L₂ and L₃.

In some examples, the camera has an aperture stop located at an image side of the lens.

In some examples, the lens has a lens height H_{L}, a closest gap G between all pairs of consecutive lens elements is smaller than 0.2 mm, and a ratio G/H_{L}<5% is fulfilled for all pairs of consecutive lens elements. In some examples, G/H_{L}<2.5%.

In some examples, a largest G is located between L₃ and L₄.

In some examples, the lens has a lens height H_{L}, a distance between L₁ and L₃ (d_{L1-L3}) fulfils d_{L1-L3}<0.75 mm, and a ratio d_{L1-L3}/H_{L}<0.2 is fulfilled. In some examples, d_{L1-L3}/H_{L}<0.15.

In some examples, TTL/EFL <1.05.

In some examples, the lens has a lens height H_{L} measured along OP1, and a ratio fulfils H_{L}/TTL <0.4. In some examples,/TTL <0.35.

In some examples, BFL/TTL >0.5.

In some examples, S8 is an image side surface of L4 and has a lens element surface diameter D₈, and a ratio of D₈ and DA fulfills DA/D₈>1.3. In some examples, DA/D₈>1.4.

In some examples, both a front surface of L₃ and a rear surface of L₃ are formed concave toward the object side.

In some examples, both a front surface of L₄ and a rear surface of L₄ are formed convex toward the object side.

In some examples, both a front surface of L₃ and a rear surface of L₃ contain 2 deflection points.

In some examples, 5 mm<DA<8 mm.

In some examples, 10 mm<EFL <20 mm.

In some examples, 5 mm<SD<10 mm.

In some examples, all lens elements are made of plastic.

In some examples, the camera is included in a camera module having a module height H_{M} in the range 7.5 mm<H_{M}<15 mm. In some examples, 9 mm<H_{M}<12 mm.

In some examples, the lens is a cut lens, cut along an axis parallel to a lens optical axis. In some examples, the lens is cut by 20% relative to an axial symmetric lens diameter and the H_{M} is reduced by >7.5% by the cutting.

In various exemplary embodiments there is provided a camera, comprising: a lens with N≥4 lens elements Lᵢ and having a lens height H_{L}, an effective focal length EFL, and a total track length TTL, each lens element has a respective focal length fᵢ and a first lens element L₁ faces an object side and a last lens element L_{N} faces an image side; an image sensor having a full sensor diagonal SD; and an optical path folding element OPFE for folding a first optical path OP1 to a second optical path OP2 perpendicular to OP1, wherein the camera is a folded camera, wherein the lens is located at an object side of the OPFE and has a lens optical axis parallel to OP1, wherein the EFL is in the range of 8 mm<EFL<40 mm, wherein M ≥1 of the lens elements are metalenses and O=N−M of the lens elements are refractive lenses, and wherein SD/EFL>0.3

In some examples, SD/EFL>0.35. In some examples, SD/EFL>0.4.

In some examples, H_{L}/TTL<20%.

In some examples, M=1 and the single metalens has a positive focal length f_{M}, and f_{M}/EFL >7.5. In some examples with M=1 and a positive f_{M}, f_{M}/EFL >15. In some examples with M=1 and a positive f_{M}, f_{M}/EFL >30. In some examples with M=1 and a positive f_{M}, 7.5<f_{M}/EFL <100. In some examples with M=1 and a positive f_{M}, 10<f_{M}/EFL <50.

In some examples with M=1, 100 mm<f_{M}<1500 mm. In some examples with M=1, 200 mm<f_{M}<1000 mm.

In some examples with M=1, the single metalens element includes L₂. In some examples with M=1, the single metalens element includes L₄.

In some examples, M=2, the two metalens elements are L₂ and L₄, L₂ has a focal length f_{M1} and L₄ has a focal length f_{M2}, and both f_{M1} and f_{M2} are positive. In some such examples, 7.5<f_{M1}/EFL and f_{M2}/EFL <100. In some such examples, 10<f_{M1}/EFL and f_{M2}/EFL <50. In some such examples, both f_{M1} and f_{M2} are in the range 100 mm<f_{M1}, f_{M2}<1500 mm. In some such examples, both f_{M1} and f_{M2} are in the range 200 mm<f_{M1}, f_{M2}<1000 mm. In some examples, 0.25<f_{M1}/f_{M2}<1.

In some examples, all refractive lenses are plastic lenses.

In some examples, the M metalenses are each located on an object side of a substrate, a height of the substrate H_{Substrate} fulfills 0.1 mm<H_{Substrate}<1 mm, and the substrate is made of glass.

In some examples, the M metalenses are each located on an object side of a substrate, a height of the substrate H_{Substrate} fulfills 0.15 mm<H_{Substrate}<0.75 mm, and the substrate is made of glass.

In some examples, N=4, and a power sequence of lens elements L₁-L₄ is positive-positive-negative-positive. In some examples N=4, and f₃ is negative with a magnitude |f₃|<EFL/2.5. In some examples, N=4, and f₃ is negative with a magnitude |f₃|<EFL/5.

In some examples, f₁ is positive and f₁<EFL/2. In some examples, f₁ is positive and f₁<EFL/1.5.

In some examples, N=4 and a power sequence of lens elements L₁-L₄ is positive-negative-negative-positive.

In some examples, N=5 and a power sequence of lens elements L₁-L₅ is positive-positive-negative-positive-positive.

In some examples, 10 mm<EFL<30 mm. In some examples, 12.5 mm<EFL<27.5 mm. In some examples, TTL/EFL <1.05. In some examples, TTL/EFL <1.0.

In some examples, BFL/TTL >0.75. In some examples, BFL/TTL >0.8.

In some examples, 4 mm<SD<15 mm. In some examples, SD>6 mm. In some examples, SD>9 mm.

In some examples, 4 mm<DA<11 mm and 2<f/#<6.5. In some examples, 6 mm<DA<9 mm and 3<f/#<5.

In some examples, f/#<4.0.

In some examples, the OPFE is a mirror.

In some examples, the camera is included in a camera module having a module height HM in the range 7.5 mm<H_{M}<15 mm. In some examples, 9 mm<H_{M}<13.5 mm.

In some examples, the camera is included in a camera module, the camera module having a module length L_{M}, and L_{M}<EFL.

In some examples, the lens and the OPFE are included in the module region, and the image sensor is included in the shoulder region.

In some examples, the camera is included in a mobile device. In some examples, the mobile device is a smartphone.

In some examples there is provided a mobile device including any of the cameras above, the mobile device having a device thickness T and a camera bump height B, the camera bump region has an elevated height T+B, and the camera is fully incorporated into the camera bump.

In some examples, a camera as above is included in a camera module that has a first module region having a module region height H_{M} and a second shoulder region having a shoulder region height H_{S}, wherein H_{M}>H_{S}. In some examples, DA >H_{S}−3 mm. In some examples, DA >H_{S}−2 mm. In some examples, DA >H_{S}−1 mm.

### BRIEF DESCRIPTION OF THE DRAWINGS

Non-limiting examples of embodiments disclosed herein are described below with reference to figures attached hereto that are listed following this paragraph. The drawings and descriptions are meant to illuminate and clarify examples disclosed herein, and should not be considered limiting in any way.

FIG. 1A illustrates a known folded Tele camera;

FIG. 1B shows schematically a known mobile device having an exterior surface and including the known folded Tele camera of FIG. 1A;

FIG. 1C illustrates another known folded Tele camera;

FIG. 1D shows schematically another known mobile device having an exterior surface and including the known folded Tele camera of FIG. 1C;

FIG. 2A shows an example of a folded Tele camera refractive lens optical system disclosed herein;

FIG. 2B shows another example of a folded Tele camera refractive lens optical system disclosed herein;

FIG. 3 shows an example of a folded Tele camera hybrid lens optical system disclosed herein;

FIG. 4 shows another example of a folded Tele camera hybrid lens optical system disclosed herein;

FIG. 5 shows yet another example of a folded Tele camera hybrid lens optical system disclosed herein;

FIG. 6 shows yet another example of a folded Tele camera hybrid lens optical system disclosed herein;

FIG. 7 shows yet another example of a folded Tele camera hybrid lens optical system disclosed herein;

FIG. 8 shows yet another example of a folded Tele camera hybrid lens optical system disclosed herein.

### DETAILED DESCRIPTION

In the following detailed description, numerous specific details are set forth in order to provide a thorough understanding. However, it will be understood by those skilled in the art that the presently disclosed subject matter may be practiced without these specific details. In other instances, well-known methods and features have not been described in detail so as not to obscure the presently disclosed subject matter.

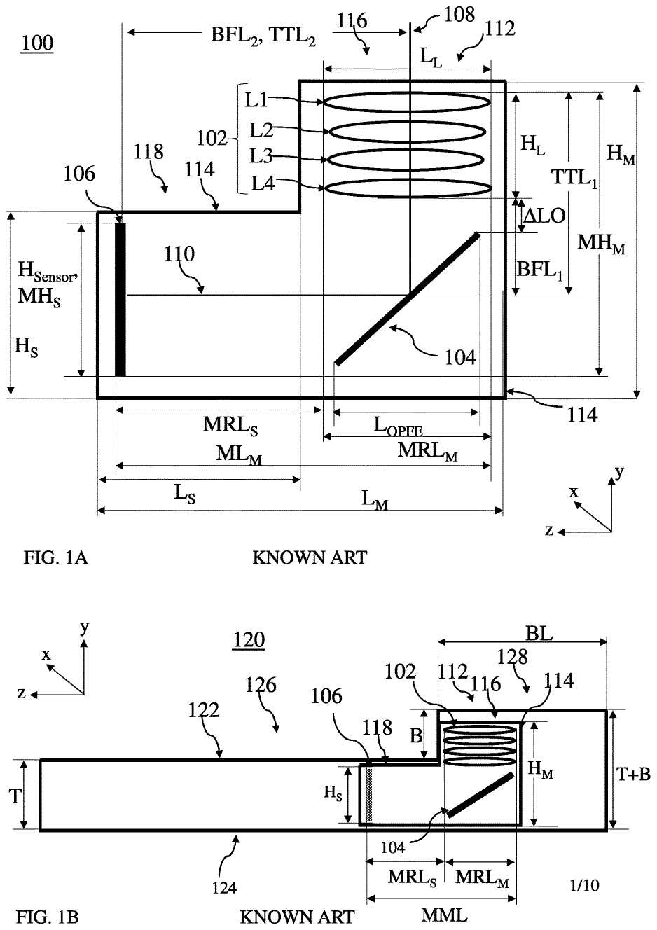

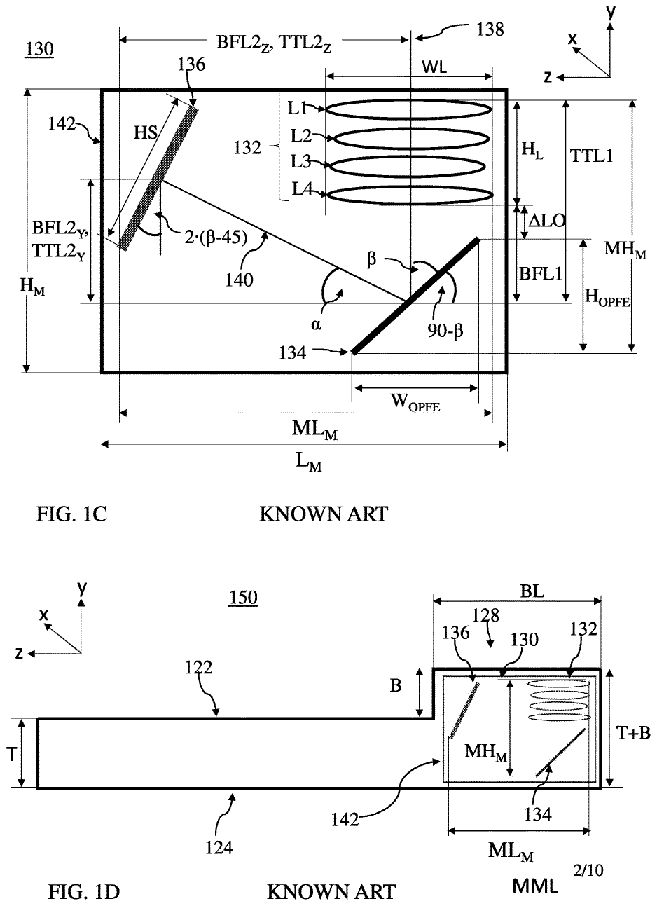

All optical lens systems disclosed in the following can be used in (or incorporated in) a known folded camera such as folded camera 100 or folded camera 130, and a resulting camera can be used in a mobile device such as mobile device 120 or mobile device 150. To clarify, all examples of optical lens systems disclosed herein are beneficial to be used in a smartphone, a tablet etc. Values and dimensions of a camera and a mobile device including optical lens systems disclosed herein are presented in Table 1. Table 1 uses the definitions and explanations given in FIGS. 1A-D.
“N” gives the number of lens elements of a lens.
“M” gives the number of metalens elements of a lens.
“ML position” gives the position where a metalens is included in a lens.
“f_{M1}” gives the focal length of a first metalens element included in a lens (in mm).
“f_{M2}” gives the focal length of a second metalens element included in a lens (in mm).
“Type” shows whether an optical lens system is a regular lens (including only glass and/or plastic lens elements) or a hybrid lens (including glass and/or plastic lens elements and in addition at least one metalens element).
SD is the (full) sensor diagonal of an image sensor (in mm).
“35 mm EqFL” gives the 35 mm equivalent focal length of the optical system.
“DA” gives the aperture diameter (in mm).
A (diagonal) field-of-view (“FOV”) is given in degrees.
“H_{L}” gives the height (or thickness) of a lens as defined in FIG. 1A and FIG. 1C (in mm). H_{L} (200) refers to a (reference) lens height of example 200. H_{L}=TTL₁−BFL₁.
MH_{M}, MH_{S}, ML_{M}, H_{M}, H_{S}, L_{M} are defined above and given in mm.

TABLE 1

| Example | 200 | 250 | 300 | 400 | 500 | 600 | 700 | 800 |
|---|---|---|---|---|---|---|---|---|
| N | 4 | 4 | 4 | 4 | 4 | 4 | 5 | 4 |
| M | 0 | 0 | 1 | 1 | 1 | 1 | 2 | 1 |
| ML position | — | — | L2 | L2 | L4 | L4 | L2, L4 | L2 |
| f_{M1} | — | — | 908 | 503 | 309 | 230 | 243 | 425 |
| f_{M2} | | | | | | | 441 | |
| Type | Plastic | Plastic | Hybrid | Hybrid | Hybrid | Hybrid | Hybrid | Hybrid |
| SD | 10.2 | 8.2 | 10.2 | 10.2 | 10.2 | 10.2 | 10.2 | 10.2 |
| TTL | 23.2 | 15.3 | 23.2 | 23.2 | 23.2 | 23.0 | 23.2 | 23.2 |
| BFL | 18.5 | 11.02 | 19.4 | 19.1 | 19.4 | 19.2 | 19.4 | 19.0 |
| EFL | 23.5 | 15.2 | 23.5 | 23.5 | 23.5 | 23.5 | 23.5 | 23.5 |
| 35 mm EqFL | 100 | | 100 | 100 | 100 | 100 | 100 | 100 |
| DA | 6.75 | 6.39 | 6.75 | 6.75 | 6.75 | 6.75 | 6.75 | 6.75 |
| f/# | 3.5 | 2.4 | 3.5 | 3.5 | 3.5 | 3.5 | 3.5 | 3.5 |
| HFOV | 13.1 | 14.8 | 13.4 | 13.4 | 13.2 | 13.2 | 13.4 | 13.4 |
| H_{L} | 5.0 | 4.6 | 3.8 | 4.1 | 3.9 | 3.9 | 3.8 | 4.2 |
| MH_{M} | 11.2 | 9.1 | 10.0 | 10.3 | 10.1 | 10.1 | 10.0 | 10.4 |
| MH_{S} | 6.1 | 4.8 | 6.1 | 6.1 | 6.1 | 6.1 | 6.1 | 6.1 |
| ML_{M} | 18.4 | 12.0 | 19.6 | 19.3 | 19.5 | 19.3 | 19.6 | 19.2 |
| H_{M} | 12.7 | 10.6 | 11.5 | 11.8 | 11.6 | 11.6 | 11.5 | 11.9 |
| H_{S} | 7.6 | 6.3 | 7.6 | 7.6 | 7.6 | 7.6 | 7.6 | 7.6 |
| L_{M} | 21.9 | 15.5 | 23.1 | 22.8 | 23.0 | 22.8 | 23.1 | 22.7 |
| H_{L}/TTL | 21.6% | 30.3% | 16.4% | 17.7% | 16.8% | 17.0% | 16.4% | 18.1% |
| BFL/TTL | 0.80 | 0.72 | 0.83 | 0.82 | 0.84 | 0.83 | 0.84 | 0.82 |
| TTL/EFL | 0.99 | 1.01 | 0.99 | 0.99 | 0.99 | 0.98 | 0.99 | 0.99 |
| SD/EFL | 0.43 | 0.54 | 0.43 | 0.43 | 0.43 | 0.43 | 0.43 | 0.43 |
| SD/H_{M} | 0.80 | 0.77 | 0.89 | 0.86 | 0.88 | 0.88 | 0.89 | 0.86 |
| L_{M}/EFL | 0.93 | 1.02 | 0.98 | 0.97 | 0.98 | 0.97 | 0.98 | 0.97 |
| f_{M1}/EFL | | | 38.64 | 21.40 | 13.15 | 9.79 | 10.34 | 18.09 |
| f_{M2}/EFL | | | | | | | 18.77 | |
| H_{L}/H_{L}(200) | 1 | | 0.76 | 0.82 | 0.78 | 0.78 | 0.76 | 0.84 |

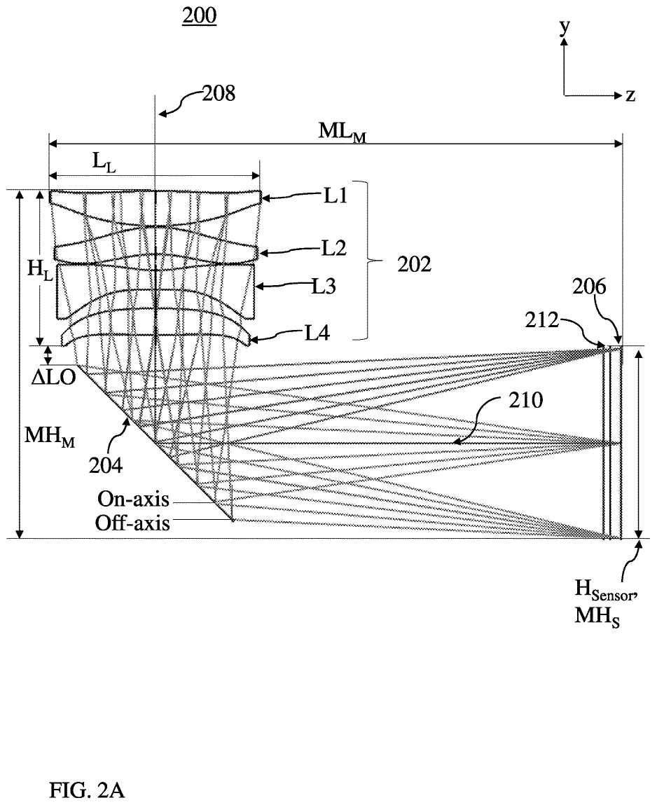

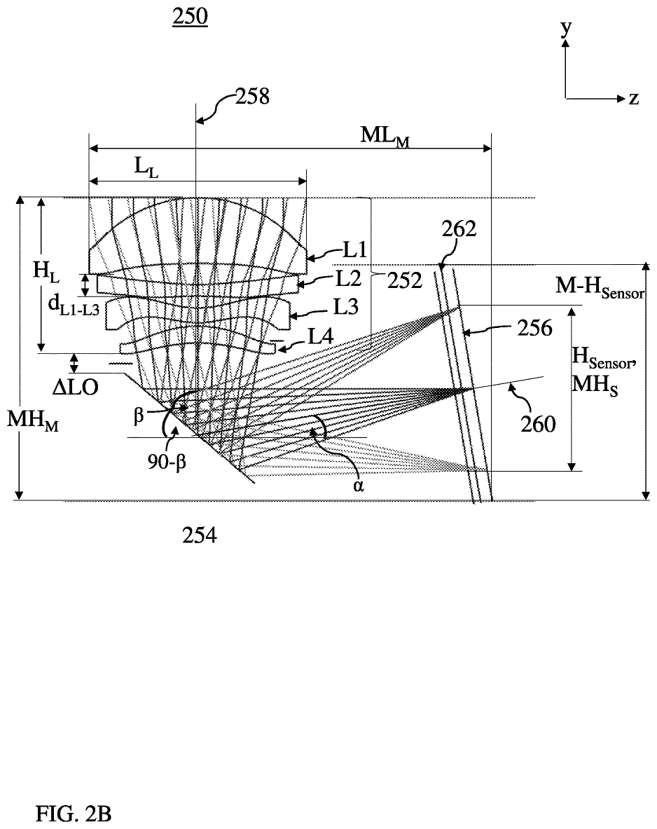

FIG. 2A shows an example of an optical lens system disclosed herein and numbered 200. Optical lens system 200 includes a regular (or “refractive”) lens, i.e. a lens not including a metalens. Optical lens system 200 comprises a lens 202 with a plurality of N lens elements (here N=4) numbered L₁-L₄, with Lᵢ being oriented towards an object side. Optical lens system 200 further comprises an OPFE 204 that folds a first OP 208 to a second OP 210, an image sensor 206 and an (optional) optical element 212, e.g. an IR filter. In optical lens system 200, OP 208 is substantially parallel to the y-axis and OP 210 is substantially parallel to the z-axis. A lens optical axis of lens 202 is oriented parallel to OP 208. OPFE 204 forms an angle of 45 degrees with both the y-axis and the z-axis. Here, OPFE 204 is a mirror.

Lens 202 is located at an object side of OPFE 204. The TTL and the BFL of camera 200 are oriented along two axes. A first part, TTL₁ and BFL₁ respectively, is parallel to OP 208, and a second part, TTL₂ and BFL₂ respectively, is parallel to OP 210. TTL and BFL are obtained by TTL=TTL₁+TTL₂ and BFL=BFL₁+BFL₂, wherein TTL₂=BFL₂. A lens height H_{L} of lens 202 is given by H_{L}=TTL₁−BFL₁. Optical rays pass through lens 202, are reflected by mirror 204, and form an image on image sensor 206. FIG. 2 shows 3 fields with 6 rays for each field. This holds also for all further optical lens systems disclosed herein.

It is noted that a value of MH_{M} depends on (i) a position (or location) of OPFE 204 with respect to the y-axis and (ii) the amount of light rays that enter camera 200. For (i), the position of OPFE 204 can be changed by increasing or decreasing ΔLO. Here, ΔLO=0.65 mm and thus MH_{M}=11.2 mm. In other examples, ΔLO may be in the range ΔLO=0.05 mm-2 mm, so that MH_{M}=10.6 mm-12.55 mm. ML_{M} changes accordingly, since TTL is not changed. For (ii), one may define a height of mirror 204 so that it includes all on-axis rays, i.e. mirror 204 may have a bottom limit as marked “On-axis”. In other examples, a height of mirror 204 may be defined so that it includes also all off-axis rays, i.e. mirror 204 may have a bottom limit as marked “Off-axis”. In image sensor 206, SD=10.2 mm. This is relatively large, compared with often used image sensors having e.g. SD=5.3 mm (⅓″ image sensor). A large image sensor is beneficial for achieving high image quality. All optical lens systems disclosed herein incorporate relatively large image sensors for a given EFL and a given H_{M}. That is, all optical lens systems disclosed herein achieve a relatively large ratios SD/EFL and SD/H_{M}, for example SD/EFL >0.4 and SD/H_{M}>0.75. In optical lens system 200, EFL=23.5 mm. In optical lens system 250, EFL=15.2 mm. In other examples, EFL may be in the range of 8 mm<EFL<50 mm.

Lens 202 includes a plurality of N lens elements Lᵢ (wherein “i” is an integer between 1 and N). L₁ is the lens element closest to the object side and L_{N} is the lens element closest to the image side, i.e. the side where the image sensor is located. This order holds for all lenses and lens elements disclosed herein. The N lens elements are axial-symmetric along an optical (lens) axis parallel to OP 208. Each lens element Lᵢ comprises a respective front surface S₂ᵢ₋₁ (the index “2i−1” being the number of the front surface) and a respective rear surface S₂ᵢ (the index “2i” being the number of the rear surface), where “i” is an integer between 1 and N. This numbering convention is used throughout the description. Alternatively, as done throughout this description, lens surfaces are marked as “Sₖ”, with k running from 1 to 2N. The front surface and the rear surface can be in some cases aspherical. This is however not limiting.

As used herein the term “front surface” of each lens element refers to the surface of a lens element located closer to the entrance of the camera (camera object side) and the term “rear surface” refers to the surface of a lens element located closer to the image sensor (camera image side).

Detailed optical data and surface data are given in Tables 2-3 for the example of the lens elements in FIG. 2A. The values provided for these examples are purely illustrative and according to other examples, other values can be used.

Surface types are defined in Table 2. The coefficients for the surfaces are defined in Table 3. The surface types are:
a) Plano: flat surfaces, no curvature
b) Q type 1 (QT1) surface sag formula:

$$z ( r ) = \frac{{cr}^{2}}{1 + \sqrt{1 - ( 1 + k ) {c}^{2} {r}^{2}}} + {D}_{con} ( u ) \qquad ( Eq . 1 )$$

$${D}_{con} ( u ) = {u}^{4} {\sum }_{n = 0}^{N} {A}_{n} {Q}_{n}^{con} ( {u}^{2} )$$

$$u = \frac{r}{{r}_{norm}} , x = {u}^{2}$$

$${Q}_{0}^{con} ( x ) = 1 \qquad {Q}_{1}^{con} = - ( 5 - 6 x ) \qquad {Q}_{2}^{con} = 15 - 14 x ( 3 - 2 x )$$

$${Q}_{3}^{con} = - \{ 35 - 12 x [ 14 - x ( 21 - 10 x ) ] \}$$

$${Q}_{4}^{con} = 70 - 3 x \{ 168 - 5 x [ 84 - 11 x ( 8 - 3 x ) ] \}$$

$${Q}_{5}^{con} = - [ 126 - x ( 1260 - 11 x \{ 420 - x [ 720 - 13 x ( 45 - 14 x ) ] \} ) ]$$

c) Even Asphere (ASP) surface sag formula:

$$z ( r ) = \frac{{cr}^{2}}{1 + \sqrt{1 - ( 1 + k ) {c}^{2} {r}^{2}}} + {α}_{1} {r}^{2} + {α}_{2} {r}^{4} + {α}_{3} {r}^{6} + {α}_{4} {r}^{8} + {α}_{5} {r}^{10} + {α}_{6} {r}^{12} + {α}_{7} {r}^{14} + {α}_{8} {r}^{16} \qquad ( Eq . 2 )$$

where {z, r} are the standard cylindrical polar coordinates, c is the paraxial curvature of the surface, k is the conic parameter, rₙₒᵣₘ is generally one half of the surface's clear aperture, and Aₙ are the polynomial coefficients shown in lens data tables. The Z axis is positive towards image. Values for CA are given as a clear aperture radius, i.e. CA/2. The reference wavelength is 555.0 nm. Units are in mm except for refraction index (“Index”) and Abbe #.

TABLE 2
Example 200

| | | | | | Aperture | | | | |
|---|---|---|---|---|---|---|---|---|---|
| | | | Curvature | | Radius | | | | Focal |
| Surface # | Comment | Type | Radius | Thickness | (D/2) | Material | Index | Abbe # | Length |
| 1 | A.S. | Plano | Infinity | 0.049 | 3.375 | | | | |
| 2 | Lens 1 | ASP | 28.396 | 1.128 | 3.375 | Plastic | 1.53 | 55.7 | 10.315 |
| 3 | | ASP | −6.779 | 0.037 | 3.370 | | | | |
| 4 | Lens 2 | ASP | 4.063 | 0.874 | 3.240 | Plastic | 1.54 | 55.9 | 89.672 |
| 5 | | ASP | 4.094 | 0.519 | 3.202 | | | | |
| 6 | Lens 3 | ASP | −4.305 | 0.623 | 3.147 | Plastic | 1.61 | 25.6 | −6.582 |
| 7 | | ASP | 79.029 | 0.605 | 2.861 | | | | |
| 8 | Lens 4 | ASP | 16.147 | 0.865 | 2.992 | Plastic | 1.66 | 20.4 | 16.808 |
| 9 | | ASP | −35.804 | 17.954 | 2.892 | | | | |
| 10 | Filter | Plano | Infinity | 0.210 | — | Glass | 1.52 | 64.2 | |
| 11 | | | Infinity | 0.350 | — | | | | |
| 12 | Image | Plano | Infinity | — | — | | | | |

EFL = 23.57 mm,
F number = 3.49,
HFOV = 13.14 deg.

Each lens element Lᵢ has a respective focal length fᵢ, given in Table 2. The FOV is given as half FOV (HFOV). The definitions for surface types, Z axis, CA values, reference wavelength, units, focal length and HFOV are valid for Tables 4-23.

TABLE 2

| | | | | | |
|---|---|---|---|---|---|
| 12 | Image | Plano | Infinity | — | — |

TABLE 3

| | Aspheric Coefficients | | | |
|---|---|---|---|---|
| Surface # | Conic | 4^{th} | 6^{th} | 8^{th} |
| 2 | 0 | 1.37E−03 | −6.45E−04 | 3.61E−05 |
| 3 | 0 | 6.82E−03 | −2.32E−03 | 4.46E−04 |
| 4 | 0 | −6.77E−03 | −2.48E−04 | −2.37E−04 |
| 5 | 0 | −1.84E−02 | 2.07E−03 | −5.15E−04 |
| 6 | 0 | 3.38E−02 | −5.28E−03 | 6.42E−04 |
| 7 | 0 | 2.70E−02 | 1.52E−03 | −2.08E−03 |
| 8 | 0 | −3.23E−03 | 5.61E−03 | −1.78E−03 |
| 9 | 0 | −1.03E−03 | 2.47E−03 | −6.56E−04 |

| | Aspheric Coefficients | | | |
|---|---|---|---|---|
| Surface # | 10^{th} | 12^{th} | 14^{th} | 16^{th} |
| 2 | 1.20E−06 | −4.17E−07 | 3.76E−08 | −1.01E−09 |
| 3 | −5.39E−05 | 4.04E−06 | −1.70E−07 | 3.31E−09 |
| 4 | 7.13E−05 | −8.17E−06 | 4.36E−07 | −9.09E−09 |
| 5 | 7.95E−05 | −6.85E−06 | 3.12E−07 | −5.95E−09 |
| 6 | −6.08E−05 | 4.15E−06 | −1.68E−07 | 2.94E−09 |
| 7 | 5.12E−04 | −6.20E−05 | 3.75E−06 | −9.05E−08 |
| 8 | 3.21E−04 | −3.22E−05 | 1.74E−06 | −4.05E−08 |
| 9 | 1.14E−04 | −1.21E−05 | 8.80E−07 | −3.21E−08 |

It is noted that herein, optical lens system 200 is shown as a “folded optical lens system”, i.e. optical lens system 200 is shown including OPFE 204 and two optical paths that are perpendicular to each other, OP 208 and OP 210. Hybrid lens systems 300, 400, 500, 600, 700 and 800 disclosed herein are not shown as folded optical lens systems, i.e. they are shown without a respective OPFE and without showing two optical paths that are perpendicular to each other. However, it is noted also that all hybrid optical lens systems disclosed herein are beneficial to be used as folded optical lens systems. Values and dimensions of all hybrid optical lens systems disclosed herein are derived with reference to optical lens system 200. For example, for estimating H_{M} of optical lens systems 300, 400, 500, 600, 700 and 800 we assume that BFL₁ is kept constant (with respect to optical lens system 200), so that a lower H_{L} of optical lens systems 300, 400, 500, 600, 700 and 800 translates into a lower HM, which is beneficial for slim mobile devices. As the TTL does not change, the lower H_{L} of optical lens systems 300, 400, 500, 600, 700 and 800 translates into a larger ML_{M} by a same amount.

In some examples, lens 202 may be cut to achieve a cut lens based on lens 202. The cut lens may be obtained by cutting a width or length of lens elements of lens 202 by 10%-40%. The cutting is of the width or length is performed along a direction parallel to the lens optical axis (i.e. parallel to the y-axis), so that a width of lens 202 measured along a x-direction (“W_{L}”) is smaller than in a length of lens 202 measured along a y-direction (“L_{L}”), i.e. W_{L}<L_{L}. The cutting of lens 202 translates to significant savings in terms of MH_{M}, which is beneficial for slim mobile device design. For example, by cutting lens 202 by 20%, H_{M} and MH_{M} may be reduced by 10-20%.

OPFE 204 forms an angle of 45 degrees with both the y-axis and the z-axis. In other examples, OPFE 204 may form a tilting angle in the range of 45<β≤65 degrees with respect to the y-axis, i.e. with respect to OP 208.

Each of L₂, L₃ and L₄ have a relatively low lens element thickness, i.e. a ratio of Tᵢ and a smallest lens element semi-diameter of the two lens element surfaces (D/2)ᵢ fulfills Tᵢ/(D/2)ᵢ<0.3 for each of L₂, L₃ and L₄. A ratio fulfills Tᵢ/(D/2)ᵢ<0.25 for L₃. Tᵢ is measured at a position of OP 208. An image sided surface of L4 is S8. S8 has a relatively small diameter D₈, a ratio of D₈ and DA fulfills DA/D₈=1.42. L₂ is meniscus convex formed toward the object side, i.e. both a front surface of L₂ and a rear surface of L₂ are formed convex toward the object side. Lᵢ is relatively thin, i.e. a thickness T₁ of Lᵢ and lens height H_{L} fulfil a ratio T₁/H_{L}<0.3. Here, T₁/H_{L}=0.23. L₁, L₂ as well as L₂, L₃ are very close to each other. Here and in the following, a pair of consecutive lens elements Lᵢ, Lᵢ₊₁ is “very close to each other”, if a closest gap (or distance) “Gᵢ” between Lᵢ and Lᵢ₊₁ and measured along the y-axis is Gᵢ<0.2 mm at some position along the z-axis between optical axis 208 and the diameter radius of Lᵢ or Lᵢ₊₁. G₁=0.037 mm (between L₁ and L₂) is located at optical axis 208, G₂ is not located at optical axis 208.

FIG. 2B shows schematically an example of an optical lens system disclosed herein and numbered 250. Optical lens system 250 includes a regular (refractive) lens. Lens system 250 can be included in a folded camera with sloped OP such as shown in FIGS. 1C-D. Lens system 250 comprises a lens 252, a mirror 254, an optical element 262 (optional) and an image sensor 256. Lens 252 includes 4 lens elements numbered L₁-L₄. Lens system 250 has a first optical path OP1 258 and a second optical path OP2 260. Lens 252 has an optical lens axis parallel to OP1 258 and parallel to the y-axis. OP2 260 is oriented perpendicular to image sensor 256. Surface types are defined in Table 4. Surface thicknesses relative to the mirror are given with respect to OP1 258 and OP2 260 respectively. The coefficients for the surfaces are defined in Table 5. The semi-diameter (D/2) of mirror 254 is defined by a circle that fully incorporates mirror 254. Dimensions of mirror 254 are 5.0×5.1 mm. The tilting angle β of mirror 254 with respect to the y-axis is 47.8 degrees. In other examples, a tilting angle β may be in the range of 45<β≤65 degrees. In yet other examples, 46<β≤50 degrees. OP2 260 is not parallel to the z-axis, but forms an angle α with the z-axis. Optical lens system 250 has a MH_{S} defined by H_{Sensor} of 4.8 mm. Also a mechanical height (“M−H_{Sensor}”) of image sensor 256 is shown. M−H_{Sensor}=7.0 mm. ΔLO=0.58 mm. TTL1=7.04 mm, BFL1=2.73 mm and TTL2=BFL2=8.29 mm, so that BFL=11.02 mm and TTL=15.33 mm. A power sequence of lens elements L₁-L₄ is plus-minus-plus-plus. An entrance pupil (or aperture stop or “A.S.”) is located after L₄, i.e. at an image side of lens 252. f₁ is positive, and f₁/EFL=0.53. Optical lens system 250 has a relatively low f/# of f/#=2.4.

Each of L₂, L₃ and L₄ have a relatively low lens element thickness, i.e. a ratio of Tᵢ and a smallest lens element semi-diameter of the two lens element surfaces (D/2)ᵢ fulfills Tᵢ/(D/2)ᵢ<0.25 for each of L₂, L₃ and L₄. A ratio fulfills Tᵢ/(D/2)ᵢ<0.2 for each of L₂ and L₃. L₁, L₂ as well as L₂, L₃ as well as L₃, L₄ are very close to each other. G₃=0.1 mm (between L₃ and L₄), and G₃ is the largest gap between any lens elements, i.e. G₁<G₃ and G₂<G₃. G₃ is located at optical axis 258. A ratio G₃/H_{L}=2.2%.

A distance between Lᵢ and L₃ (“d_{L1-L3}”) is relatively small, i.e. d_{L1-L3}<0.75 mm and ratio d_{L1-L3}/H_{L}<0.2. Specifically, d_{L1-L3}=0.63 mm and d_{L1-L3}/H_{L}=0.14. In other words, L₂ expands over (or occupies) a relatively low distance. Small Gᵢ, small Tᵢ and small distances

Example 250

| Surface | | | Curvature | | Aperture | | | | Focal |
|---|---|---|---|---|---|---|---|---|---|
| # | Comment | Type | Radius | Thickness | Radius (D/2) | Material | Index | Abbe # | Length |
| 1 | Lens 1 | QT1 | 3.954 | 1.954 | 3.197 | Plastic | 1.54 | 56.0 | 8.090 |
| 2 | | | 30.986 | 0.624 | 2.967 | | | | |
| 3 | Lens 2 | QT1 | −6.991 | 0.340 | 2.951 | Plastic | 1.67 | 19.2 | −6.146 |
| 4 | | | 10.502 | 0.350 | 2.827 | | | | |
| 5 | Lens 3 | QT1 | −2.891 | 0.440 | 2.693 | Plastic | 1.64 | 22.5 | 19.612 |

EFL = 15.20 mm,
F number = 2.41,
HFOV = 14.84 degrees

between lens elements are beneficial for slim a slim camera.

An image sided surface of L4 is S8. S8 has a relatively small diameter D₈, a ratio of D₈ and DA fulfills DA/D₈=1.42.

L₄ is meniscus convex formed toward the object side, i.e. both a front surface of L₄ and a rear surface of L₄ are formed convex toward the object side. S5 and S6 (i.e. both surfaces of L₃) are formed concave toward the object side and they each contain two deflection points. In other examples, lens 252 may be cut to achieve a cut lens based on lens 252.

TABLE 4

| | | | | | | | | | |
|---|---|---|---|---|---|---|---|---|---|
| 6 | | | −2.496 | 0.100 | 2.350 | | | | |
| 7 | Lens 4 | QT1 | 3.710 | 0.501 | 2.269 | Plastic | 1.67 | 19.2 | 33.621 |
| 8 | | | 4.191 | 0.338 | 2.258 | | | | |
| 9 | A.S. | Plano | Infinity | 2.392 | 2.251 | | | | |
| 10 | Mirror | Plano | Infinity | 7.586 | — | | | | |
| 11 | Filter | Plano | Infinity | 0.210 | — | Glass | 1.52 | 64.2 | |
| 12 | | | Infinity | 0.350 | — | | | | |
| 13 | Image | Plano | Infinity | — | — | | | | |

TABLE 5
Aspheric Coefficients

| Surface # | Norm Radius | A0 | A1 | A2 | A3 | A4 |
|---|---|---|---|---|---|---|
| 1 | 3.197 | −2.63E−02 | −3.11E−02 | −1.75E−02 | −8.05E−03 | −3.36E−03 |
| 2 | 2.967 | 2.29E−01 | −5.22E−02 | −8.94E−03 | −4.92E−03 | 6.18E−04 |
| 3 | 2.951 | 4.26E−01 | −7.64E−02 | 2.24E−02 | −6.06E−03 | 2.73E−03 |
| 4 | 2.827 | −5.76E−01 | 1.07E−01 | −1.21E−02 | −1.21E−02 | 7.43E−03 |
| 5 | 2.693 | 1.62E+00 | 2.80E−02 | 2.03E−02 | 7.34E−04 | −8.28E−05 |
| 6 | 2.350 | 1.81E+00 | −3.69E−02 | 4.38E−02 | 5.43E−03 | 2.90E−03 |
| 7 | 2.269 | −1.67E−01 | −8.47E−02 | 6.43E−03 | −5.50E−03 | 7.77E−04 |
| 8 | 2.258 | −3.28E−01 | −1.42E−02 | −1.36E−02 | 3.22E−03 | −1.57E−03 |
| Surface # | A5 | A6 | A7 | A8 | A9 | A10 |
| 1 | −9.55E−04 | −1.83E−04 | −2.50E−05 | −2.46E−05 | −3.32E−05 | −8.07E−06 |
| 2 | 1.94E−03 | 2.80E−04 | −2.86E−04 | −2.74E−04 | 9.81E−06 | 4.11E−05 |
| 3 | 6.24E−04 | 3.76E−04 | −3.96E−04 | −7.71E−05 | 1.16E−04 | −3.13E−05 |
| 4 | 1.06E−03 | −4.06E−04 | −4.94E−04 | 1.57E−04 | 1.19E−04 | −4.10E−05 |
| 5 | 4.55E−03 | −2.92E−05 | 2.22E−04 | −1.52E−04 | 9.61E−05 | 1.21E−05 |
| 6 | 5.03E−04 | 3.82E−04 | 2.13E−04 | 1.72E−04 | 1.36E−05 | 1.23E−05 |
| 7 | −4.89E−04 | 1.63E−05 | −9.46E−05 | 1.72E−05 | −1.96E−05 | 6.56E−06 |
| 8 | 5.25E−04 | −2.24E−04 | 3.64E−05 | −1.17E−05 | 3.29E−06 | 8.78E−06 |

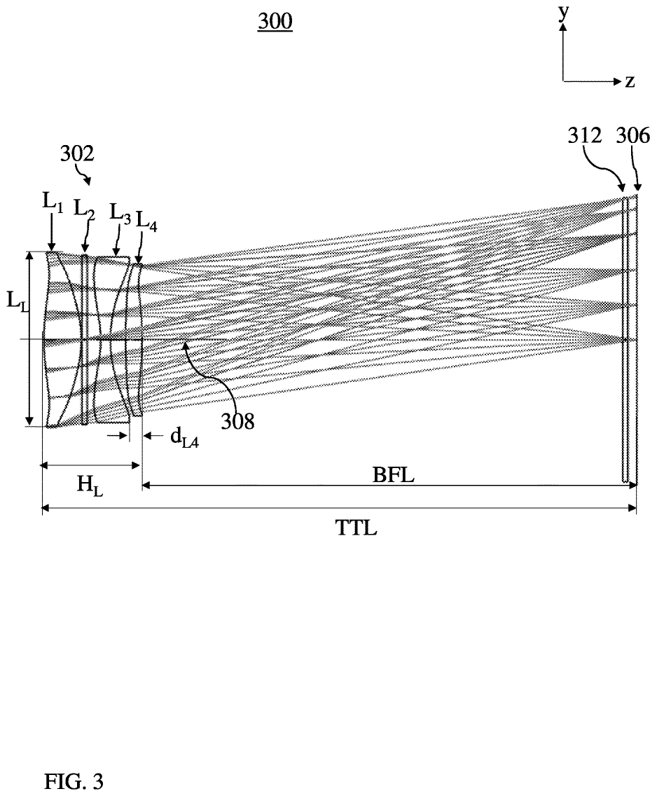

FIG. 3 shows another example of an optical lens system disclosed herein and numbered 300. Optical lens system 300 includes a hybrid lens 302, i.e. a lens that does include at least one metalens element. Lens 302 includes a plurality of N=4 lens elements numbered L₁-L₄. Optical lens system 300 includes as well an image sensor 306 and an (optional) optical element 312, e.g. an IR filter. In other examples, optical lens system 300 may further comprise an OPFE (not shown) that folds an OP1 to an OP2 (not shown). OP1 is substantially parallel to the y-axis and OP2 is substantially parallel to the z-axis. A lens optical axis of lens 302 is oriented parallel to OP1. The OPFE may form an angle of 45 degrees with both the y-axis and the z-axis.

Here, L₂ is a metalens element. The metalens element is manufactured (or located) on top of a substrate. In other words, the metalens element is located on a front surface (object side) of a substrate. This holds for all following metalens elements. The substrate has a substrate height H_{Substrate}. Here, H_{Substrate}=0.2 mm. In other examples, H_{Substrate} may be in the range 0.05 mm<H_{Substrate}<1 mm. The substrate is made of glass. This holds for all following metalens elements.

Compared to regular lens 202 of optical lens system 200, hybrid lens 302 of optical lens system 300 has a significantly lower H_{L}, although optical properties (EFL, SD, DA etc.) of a respective camera including regular lens 202 or hybrid lens 302 are identical. Specifically, a H_{L} of hybrid lens 302 is 24% lower than a H_{L} of regular lens 202. This shows that hybrid lenses are beneficial for use in slim mobile cameras.

L₄ expands over a relatively low distance (“d_{L4}”). d_{L4}=0.53 mm and a ratio d_{L4}/H_{L}=0.14. G₁=0.032 mm and is located at optical axis 308. G₂ is not located at optical axis 308. G₂=0.25 mm, so that L₂ and L₃ are not very close to each other. This may be beneficial for using a thicker substrate having a H_{Substrate}>0.2 mm, without the need for increasing H_{L} significantly.

Surface types are defined in Table 6. The coefficients for the surfaces of the regular lens elements (L₁, L₃, L₄) are defined in Table 7. Phase coefficients of the metalens element (L₂) are defined in Table 8. The phase coefficients are given according to the following polynomial expansion (here: coefficients Aᵢ), as used in Binary Optic 2 in Zemax (M is the diffraction order, here M=1):

$$Φ = M {\sum }_{i = 1}^{N} {A}_{i} {ρ}^{2 i}$$

TABLE 6

| | Aspheric Coefficients | | | |
|---|---|---|---|---|
| Surface # | Conic | 4^{th} | 6^{th} | 8^{th} |
| 2 | 0 | −2.83E−03 | −3.18E−04 | 7.15E−05 |

TABLE 7
Example 300

| | | | | | Aperture |
|---|---|---|---|---|---|
| | | | Curvature | | Radius |
| Surface # | Comment | Type | Radius | Thickness | (D/2) |
| 1 | A.S. | Plano | Infinity | −0.053 | 3.375 |
| 2 | Lens 1 | ASP | 8.818 | 1.460 | 3.375 |
| 3 | | ASP | −4.506 | 0.032 | 3.396 |
| 4 | Lens 2 | Bin2 | Infinity | 0.200 | 3.280 |
| 5 | | Plano | Infinity | 0.535 | 3.262 |
| 6 | Lens 3 | ASP | −3.891 | 0.377 | 3.214 |
| 7 | | ASP | 5.467 | 0.595 | 2.963 |
| 8 | Lens 4 | ASP | 18.153 | 0.644 | 2.947 |
| 9 | | ASP | −11.810 | 18.798 | 2.916 |
| 10 | Filter | Plano | Infinity | 0.210 | — |
| 11 | | | Infinity | 0.350 | — |
| 12 | Image | Plano | Infinity | — | — |
| | | | | | Focal |
| | Surface # | Material | Index | Abbe # | Length |
| | 1 | | | | |
| | 2 | Plastic | 1.54 | 55.9 | 5.681 |
| | 3 | | | | |
| | 4 | Glass | 1.46 | 67.8 | 907.693 |
| | 5 | | | | |
| | 6 | Plastic | 1.59 | 28.4 | −3.788 |
| | 7 | | | | |
| | 8 | Plastic | 1.66 | 20.4 | 10.827 |
| | 9 | | | | |
| | 10 | Glass | 1.52 | 64.2 | |
| | 11 | | | | |
| | 12 | | | | |
| 3 | 0 | 8.15E−03 | −4.66E−04 | 3.55E−05 | |
| 6 | 0 | 2.77E−02 | −2.00E−03 | −2.38E−04 | |
| 7 | 0 | −2.72E−03 | 3.16E−03 | −1.17E−03 | |
| 8 | 0 | −7.35E−03 | 1.39E−03 | 1.26E−06 | |
| 9 | 0 | 1.05E−03 | 1.02E−05 | 7.76E−05 | |
| | Aspheric Coefficients | | | | |
| Surface # | 10^{th} | 12^{th} | 14^{th} | 16^{th} | |
| 2 | −1.27E−05 | 9.02E−07 | −2.04E−08 | 1.21E−10 | |
| 3 | −1.32E−05 | 2.06E−06 | −1.37E−07 | 3.66E−09 | |
| 6 | 8.00E−05 | −7.87E−06 | 3.51E−07 | −5.75E−09 | |
| 7 | 2.06E−04 | −2.08E−05 | 1.17E−06 | −2.84E−08 | |
| 8 | −2.45E−06 | −2.04E−06 | 3.36E−07 | −1.74E−08 | |
| 9 | 1.06E−06 | −2.11E−07 | −7.87E−09 | −2.37E−09 | |

EFL = 23.32 mm,
F number = 3.45,
HFOV = 13.39 deg.

TABLE 8

| | Phase Coefficients | | | | |
|---|---|---|---|---|---|
| Surface # | Norm Radius | p² | p⁴ | p⁶ | p⁸ |
| 4 | 3.280 | −67.093 | 752.700 | −2849.411 | 5019.548 |

Phase Coefficients

| Surface # | p¹⁰ | p¹² | p¹⁴ | p¹⁶ |
|---|---|---|---|---|
| 4 | −5697.100 | 4747.520 | −2633.649 | 658.718 |

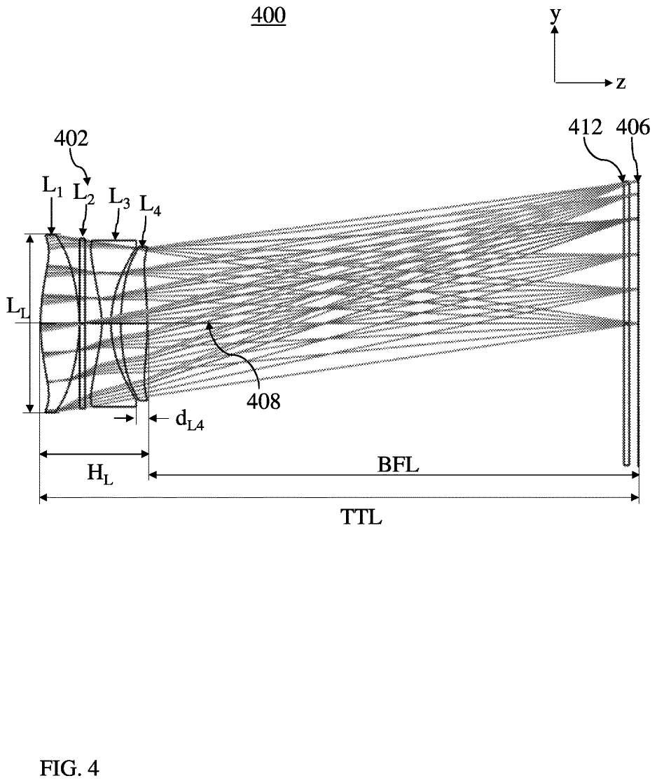

FIG. 4 shows another example of an optical lens system disclosed herein and numbered 400. Optical lens system 400 includes a hybrid lens. L₂ is a metalens element. Optical lens system 400 comprises a lens 402 with a plurality of N lens elements (here N=4) numbered L₁-L₄, an image sensor 406 and an (optional) optical element 412. In other examples, optical lens system 400 may further comprise an OPFE (not shown) that folds an OP1 to an OP2 (not shown). A lens optical axis of lens 402 may be oriented parallel to OP1. The OPFE forms an angle of 45 degrees with both the y-axis and the z-axis.

L₄ expands over a relatively low distance (“d_{L4}”). d_{L4}=0.48 mm and a ratio d_{L4}/H_{L}=0.12. G₁=0.02 mm and is located at optical axis 408. G₂=0.17 mm is not located at optical axis 408.

Surface types are defined in Table 9. The coefficients for the surfaces of the regular lens elements (L₁, L₃, L₄) are defined in Table 10. Phase coefficients of the metalens element (L₂) are defined in Table 11.

TABLE 9

| | Aspheric Coefficients | | | |
|---|---|---|---|---|
| Surface # | Conic | 4^{th} | 6^{th} | 8^{th} |
| 2 | 0 | −1.64E−03 | −2.68E−04 | 6.34E−05 |
| 3 | 0 | 5.05E−03 | −1.75E−04 | −2.86E−06 |
| 6 | 0 | 2.37E−02 | −2.04E−03 | −1.76E−04 |
| 7 | 0 | −9.58E−03 | 4.00E−03 | −1.19E−03 |
| 8 | 0 | −1.01E−02 | 2.00E−03 | −7.71E−05 |
| 9 | 0 | 3.05E−03 | −4.86E−04 | 1.59E−04 |

TABLE 10
Aspheric Coefficients
Example 400

| | | | | | Aperture |
|---|---|---|---|---|---|
| | | | Curvature | | Radius |
| Surface # | Comment | Type | Radius | Thickness | (D/2) |
| 1 | A.S. | Plano | Infinity | −0.159 | 3.375 |
| 2 | Lens 1 | ASP | 7.844 | 1.507 | 3.375 |
| 3 | | ASP | −5.919 | 0.018 | 3.419 |
| 4 | Lens 2 | Bin2 | Infinity | 0.200 | 3.271 |
| 5 | | Plano | Infinity | 0.647 | 3.248 |
| 6 | Lens 3 | ASP | −3.871 | 0.364 | 3.202 |
| 7 | | ASP | 4.096 | 0.373 | 2.944 |
| 8 | Lens 4 | ASP | 6.364 | 1.031 | 2.959 |
| 9 | | ASP | −13.157 | 18.501 | 2.945 |
| 10 | Filter | Plano | Infinity | 0.210 | — |
| 11 | | | Infinity | 0.350 | — |
| 12 | Image | Plano | Infinity | — | — |
| | | | | | Focal |
| | Surface # | Material | Index | Abbe # | Length |
| | 1 | | | | |
| | 2 | Plastic | 1.54 | 55.9 | 6.426 |
| | 3 | | | | |
| | 4 | Glass | 1.46 | 67.8 | 502.884 |
| | 5 | | | | |
| | 6 | Plastic | 1.59 | 28.4 | −3.310 |
| | 7 | | | | |
| | 8 | Plastic | 1.64 | 23.5 | 6.801 |
| | 9 | | | | |
| | 10 | Glass | 1.52 | 64.2 | |
| | 11 | | | | |
| | 12 | | | | |

EFL = 22.95 mm,
F number = 3.40,
HFOV = 13.42 deg.

| Surface # | 10^{th} | 12^{th} | 14^{th} | 16^{th} |
|---|---|---|---|---|
| 2 | −1.09E−05 | 4.42E−07 | 9.38E−09 | −4.34E−10 |

Example 500

| | | | | |
|---|---|---|---|---|
| 3 | −1.26E−05 | 2.28E−06 | −1.57E−07 | 4.10E−09 |
| 6 | 7.36E−05 | −7.49E−06 | 3.35E−07 | −5.49E−09 |
| 7 | 2.05E−04 | −2.14E−05 | 1.27E−06 | −3.42E−08 |
| 8 | 3.94E−06 | −3.68E−06 | 5.79E−07 | −2.85E−08 |
| 9 | −8.47E−06 | −1.05E−06 | 2.01E−07 | −1.12E−08 |

EFL = 23.54 mm,
F number = 3.49,
HFOV = 13.24 deg.

TABLE 11

| | Phase Coefficients | | | | |
|---|---|---|---|---|---|
| Surface # | Norm Radius | p² | p⁴ | p⁶ | p⁸ |
| 4 | 3.271 | −120.419 | 858.949 | −2971.319 | 4925.013 |

Phase Coefficients

| Surface # | p¹⁰ | p¹² | p¹⁴ | p¹⁶ |
|---|---|---|---|---|
| 4 | −4421.756 | 2237.884 | −724.374 | 149.164 |

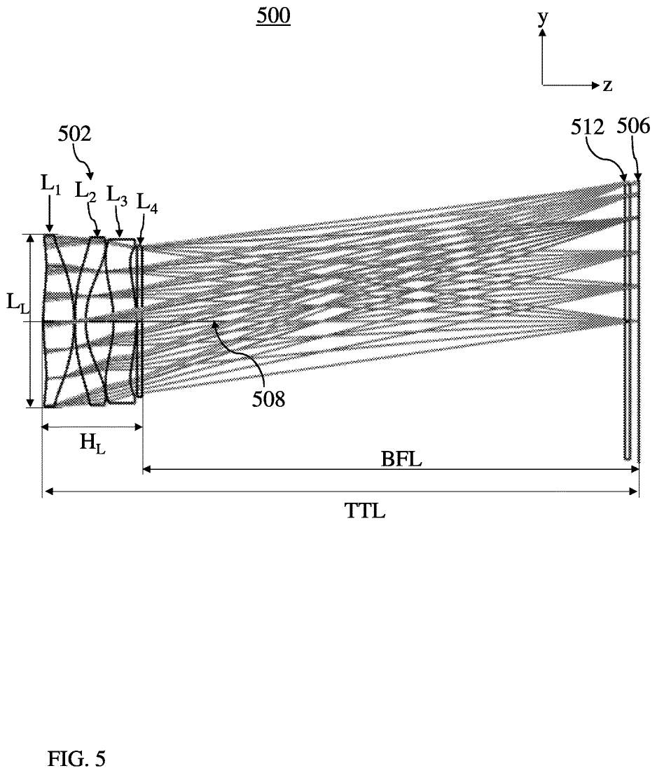

FIG. 5 shows another example of an optical lens system disclosed herein and numbered 500. Optical lens system 500 includes a hybrid lens. Here, L₄ is a metalens element. Optical lens system 500 comprises a lens 502 with a plurality of N lens elements (here N=4) numbered L₁-L₄, an image sensor 506 and an (optional) optical element 512. Optical lens system 500 may further comprise an OPFE (not shown) that folds an OP1 to an OP2 (not shown). A lens optical axis of lens 502 may be oriented parallel to OP1. The OPFE forms an angle of 45 degrees with both the y-axis and the z-axis. Lᵢ is relatively thin, T₁/H_{L}=0.25. G₁=0.02 mm and is located at optical axis 508. G₃=0.03 mm and is located at optical axis 508. Both a front surface and a rear surface of L₂ are shaped convex with respect to an object side. Both a front surface and a rear surface of L₃ are shaped concave with respect to an object side. Surface types are defined in Table 12. The coefficients for the surfaces of the regular lens elements (L₁, L₂, L₃) are defined in Table 13. Phase coefficients of the metalens element (L₄) are defined in Table 14.

TABLE 12

| | | | | | Aperture | | | | |
|---|---|---|---|---|---|---|---|---|---|
| | | | Curvature | | Radius | | | | Focal |
| Surface # | Comment | Type | Radius | Thickness | (D/2) | Material | Index | Abbe # | Length |
| 1 | A.S. | Plano | Infinity | 0.039 | 3.375 | | | | |
| 2 | Lens 1 | ASP | 17.859 | 0.965 | 3.375 | Plastic | 1.54 | 55.9 | 9.277 |
| 3 | | ASP | −6.937 | 0.017 | 3.340 | | | | |
| 4 | Lens 2 | ASP | 6.489 | 0.779 | 3.299 | Plastic | 1.54 | 55.9 | −18.772 |
| 5 | | ASP | 3.805 | 1.250 | 3.148 | | | | |
| 6 | Lens 3 | ASP | −4.569 | 0.799 | 3.142 | Plastic | 1.67 | 19.2 | −39.455 |
| 7 | | ASP | −5.902 | −0.025 | 2.937 | | | | |
| 8 | Lens 4 | Bin2 | Infinity | 0.200 | 2.941 | Glass | 1.46 | 67.8 | 309.049 |
| 9 | | Plano | Infinity | 18.879 | 2.951 | | | | |
| 10 | Filter | Plano | Infinity | 0.210 | — | Glass | 1.52 | 64.2 | |
| 11 | | | Infinity | 0.350 | — | | | | |
| 12 | Image | Plano | Infinity | — | — | | | | |

EFL = 23.54 mm,
F number = 3.49,
HFOV = 13.24 deg.

TABLE 13
Example 600
Aspheric Coefficients

| Surface # | Conic | 4^{th} | 6^{th} | 8^{th} |
|---|---|---|---|---|
| 2 | 0 | −4.93E−03 | −6.30E−04 | 2.09E−04 |
| 3 | 0 | 8.56E−05 | −2.89E−04 | 1.43E−04 |
| 4 | 0 | 3.44E−03 | −6.08E−04 | 1.32E−04 |
| 5 | 0 | 2.74E−03 | −2.60E−03 | 2.59E−04 |
| 6 | 0 | 1.62E−02 | −1.92E−03 | 7.16E−05 |
| 7 | 0 | 7.29E−03 | 1.35E−03 | −8.51E−04 |

| Surface # | 10^{th} | 12^{th} | 14^{th} | 16^{th} |
|---|---|---|---|---|
| 2 | −2.63E−05 | 2.19E−06 | −1.04E−07 | 2.09E−09 |
| 3 | −2.32E−05 | 2.25E−06 | −1.11E−07 | 2.18E−09 |
| 4 | −1.84E−05 | 2.04E−06 | −1.62E−07 | 5.43E−09 |
| 5 | 3.84E−06 | −2.51E−06 | 1.40E−07 | −2.26E−09 |
| 6 | 4.77E−05 | −8.57E−06 | 6.24E−07 | −1.82E−08 |
| 7 | 2.31E−04 | −3.24E−05 | 2.44E−06 | −7.72E−08 |

EFL = 23.53 mm,
F number = 3.48,
HFOV = 13.26 deg.

TABLE 14

| | Phase Coefficients | | | | |
|---|---|---|---|---|---|
| Surface # | Norm Radius | p² | p⁴ | p⁶ | p⁸ |
| 8 | 2.941 | −158.422 | 799.812 | −4272.130 | 10010.085 |

Phase Coefficients

| Surface # | p¹⁰ | p¹² | p¹⁴ | p¹⁶ |
|---|---|---|---|---|
| 8 | −8890.556 | −106.061 | 3962.709 | −1399.755 |

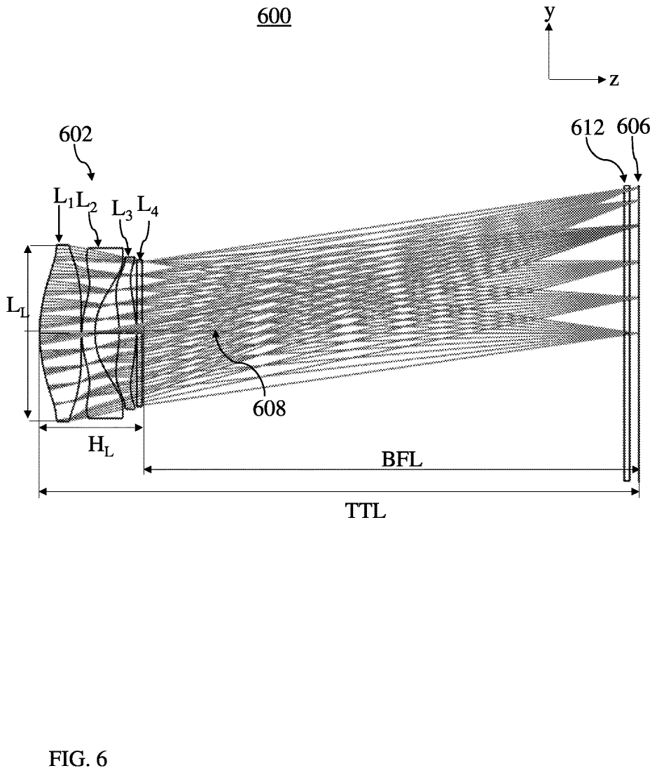

FIG. 6 shows another example of an optical lens system disclosed herein and numbered 600. Optical lens system 600 includes a hybrid lens. Here, L₄ is a metalens element. Optical lens system 600 comprises a lens 602 with a plurality of N=4 lens elements numbered L₁-L₄, an image sensor 606 and an (optional) optical element 612. Optical lens system 600 may further comprise an OPFE (not shown) that folds a first OP1 to a second OP2 (not shown). A lens optical axis 608 of lens 602 is oriented parallel to OP1. OPFE forms an angle of 45 degrees with both the y-axis and the z-axis.

G₁=0.02 mm and is located at optical axis 608. G₃=0.02 mm and is located at optical axis 608 as well. Both a front surface and a rear surface of L₂ are shaped convex with respect to an object side. L₃ expands over a relatively low distance (“d_{L3}”). d_{L3}=0.5 mm and a ratio d_{L3}/H_{L}=0.12.

Surface types are defined in Table 15. The coefficients for the surfaces of the regular lens elements (L₁, L₂, L₃) are defined in Table 16. Phase coefficients of the metalens element (L₄) are defined in Table 17.

TABLE 15

| | | | | | Radius | | | | |
|---|---|---|---|---|---|---|---|---|---|
| | | | Radius | | (D/2) | | | | Length |
| 1 | A.S. | Plano | Infinity | −0.605 | 3.375 | | | | |
| 2 | Lens 1 | ASP | 6.247 | 1.595 | 3.375 | Plastic | 1.54 | 55.9 | 15.369 |
| 3 | | ASP | 22.225 | 0.021 | 3.349 | | | | |
| 4 | Lens 2 | ASP | 3.794 | 0.511 | 3.235 | Plastic | 1.61 | 25.6 | −54.793 |
| 5 | | ASP | 3.237 | 0.929 | 2.929 | | | | |
| 6 | Lens 3 | ASP | −4.563 | 0.658 | 2.889 | Plastic | 1.67 | 19.2 | −74.659 |
| 7 | | ASP | −5.308 | 0.022 | 2.802 | | | | |
| 8 | Lens 4 | Bin2 | Infinity | 0.200 | 2.790 | Glass | 1.46 | 67.8 | 230.492 |
| 9 | | Plano | Infinity | 18.558 | 2.770 | | | | |
| 10 | Filter | Plano | Infinity | 0.210 | — | Glass | 1.52 | 64.2 | |
| 11 | | | Infinity | 0.350 | — | | | | |
| 12 | Image | Plano | Infinity | — | — | | | | |

TABLE 16

| | Aspheric Coefficients | | | |
|---|---|---|---|---|
| Surface # | Conic | 4^{th} | 6^{th} | 8^{th} |
| 2 | 0 | −1.58E−03 | 2.64E−04 | −7.55E−05 |
| 3 | 0 | −2.46E−02 | 5.27E−03 | −5.56E−04 |
| 4 | 0 | 7.90E−03 | −1.28E−02 | 2.06E−03 |
| 5 | 0 | 5.05E−02 | −2.40E−02 | 4.13E−03 |
| 6 | 0 | 2.55E−02 | 4.08E−04 | −5.77E−05 |
| 7 | 0 | 5.83E−03 | 4.47E−03 | −1.90E−03 |

| | Aspheric Coefficients | | | |
|---|---|---|---|---|
| Surface # | 10^{th} | 12^{th} | 14^{th} | 16^{th} |
| 2 | 1.58E−05 | −2.35E−06 | 1.49E−07 | −2.97E−09 |
| 3 | −2.52E−06 | 6.18E−06 | −5.34E−07 | 1.52E−08 |
| 4 | −9.59E−05 | −5.50E−06 | 7.09E−07 | −2.00E−08 |
| 5 | −2.24E−04 | −2.70E−05 | 4.02E−06 | −1.45E−07 |
| 6 | −7.25E−06 | 2.29E−07 | −3.85E−07 | 3.50E−08 |
| 7 | 4.37E−04 | −4.87E−05 | 2.27E−06 | −2.36E−08 |

TABLE 17

| | Phase Coefficients | | | | |
|---|---|---|---|---|---|
| Surface | Norm | | | | |
| # | Radius | p² | p⁴ | p⁶ | p⁸ |
| 8 | 2.790 | −191.160 | 1,883.493 | −10,062.859 | 30,978.340 |

| Surface | Phase Coefficients | | | |
|---|---|---|---|---|
| # | p¹⁰ | p¹² | p¹⁴ | p¹⁶ |
| 8 | −57,067.055 | 61,055.835 | −34,340.180 | −3,222.114 |

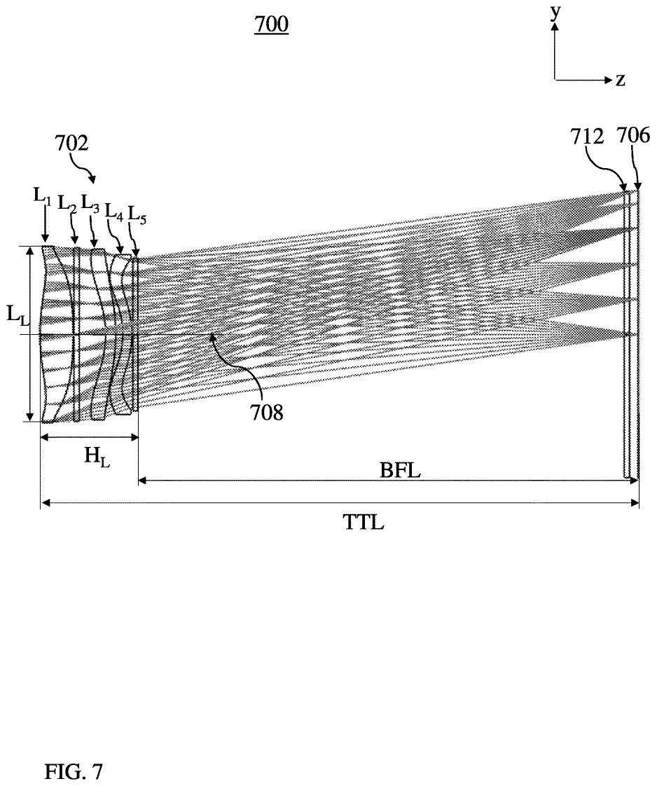

FIG. 7 shows another example of an optical lens system disclosed herein and numbered 700. Optical lens system 700 includes a hybrid lens. Here, L₂ and L₄ are metalens elements. Optical lens system 700 comprises a lens 702 with a plurality of N=5 lens elements numbered L₁-L₅, an image sensor 706 and an (optional) optical element 712. Optical lens system 700 may further comprise an OPFE (not shown) that folds a first OP1 to a second OP2 (not shown). A lens optical axis of lens 708 is oriented parallel to first OP1. The OPFE forms an angle of 45 degrees with both the y-axis and the z-axis.

G₁=0.04 mm and is located at optical axis 708. G₄=0.04 mm (between L₄ and L₅) and is located at optical axis 708 as well. A front surface and a rear surface of both L₃ and of L₄ are shaped concave with respect to an object side. G₂ is not located at optical axis 708. G₂=0.42 mm, so that L₂ and L₃ are not very close to each other.

Surface types are defined in Table 18. The coefficients for the surfaces of the regular lens elements (L₁, L₂, L₃) are defined in Table 19. Phase coefficients of the metalens elements (L₂, L₄) are defined in Table 20.

TABLE 18

| | | | | | Aperture | | | | |
|---|---|---|---|---|---|---|---|---|---|
| | | | Curvature | | Radius | | | | Focal |
| Surface # | Comment | Type | Radius | Thickness | (D/2) | Material | Index | Abbe # | Length |
| 1 | A.S. | Plano | Infinity | −0.034 | 3.375 | | | | |
| 2 | Lens 1 | ASP | 7.943 | 1.283 | 3.375 | Plastic | 1.57 | 37.4 | 9.768 |
| 3 | | ASP | −17.519 | 0.037 | 3.389 | | | | |
| 4 | Lens 2 | Bin2 | Infinity | 0.200 | 3.333 | Glass | 1.46 | 67.8 | 243.158 |
| 5 | | Plano | Infinity | 1.029 | 3.321 | | | | |
| 6 | Lens 3 | ASP | −3.889 | 0.385 | 3.277 | Plastic | 1.57 | 37.4 | −12.074 |
| 7 | | ASP | −9.267 | 0.274 | 3.194 | | | | |
| 8 | Lens 4 | ASP | −3.717 | 0.361 | 3.065 | Plastic | 1.67 | 19.2 | 165.161 |
| 9 | | ASP | −3.738 | 0.037 | 2.906 | | | | |
| 10 | Lens 5 | Bin2 | Infinity | 0.200 | 2.916 | Glass | 1.46 | 67.8 | 440.621 |
| 11 | | Plano | Infinity | 18.886 | 2.935 | | | | |
| 12 | Filter | Plano | Infinity | 0.210 | — | Glass | 1.52 | 64.2 | |
| 13 | | | Infinity | 0.350 | — | | | | |
| 14 | Image | Plano | Infinity | — | — | | | | |

TABLE 19

| | Aspheric Coefficients | | | |
|---|---|---|---|---|
| Surface # | Conic | 4^{th} | 6^{th} | 8^{th} |
| 2 | 0 | −3.19E−03 | 2.39E−04 | −1.85E−04 |
| 3 | 0 | −4.07E−03 | −3.32E−04 | 3.66E−05 |
| 6 | 0 | 1.90E−03 | 4.81E−03 | −1.17E−03 |
| 7 | 0 | −1.41E−02 | 6.99E−03 | −1.34E−03 |
| 8 | 0 | −1.92E−02 | 1.07E−02 | −1.21E−03 |
| 9 | 0 | −6.63E−03 | 7.52E−03 | −9.20E−04 |

| | Aspheric Coefficients | | | |
|---|---|---|---|---|
| Surface # | 10^{th} | 12^{th} | 14^{th} | 16^{th} |
| 2 | 3.18E−05 | −3.44E−06 | 2.24E−07 | −5.73E−09 |
| 3 | 4.32E−06 | −1.05E−06 | 7.23E−08 | −1.31E−09 |
| 6 | 1.40E−04 | −7.74E−06 | 1.31E−07 | 2.52E−09 |
| 7 | 1.24E−04 | −3.92E−06 | −1.63E−07 | 1.09E−08 |
| 8 | 2.79E−05 | 7.48E−06 | −7.99E−07 | 2.54E−08 |
| 9 | 5.69E−05 | 1.51E−06 | −5.65E−07 | 2.68E−08 |

TABLE 20

| | Phase Coefficients | | | | |
|---|---|---|---|---|---|
| Surface | Norm | | | | |
| # | Radius | p² | p⁴ | p⁶ | p⁸ |
| 4 | 3.333 | −258.672 | −1,530.846 | 7,409.686 | −19,203.322 |
| 10 | 2.916 | −109.260 | 1,879.034 | −6,407.806 | 17,195.690 |

| Surface | Phase Coefficients | | | |
|---|---|---|---|---|
| # | p¹⁰ | p¹² | p¹⁴ | p¹⁶ |
| 4 | 29,442.017 | −27,160.002 | 14,148.610 | −3,222.114 |
| 10 | −29,123.066 | 27,644.623 | −13,348.989 | 2,544.526 |

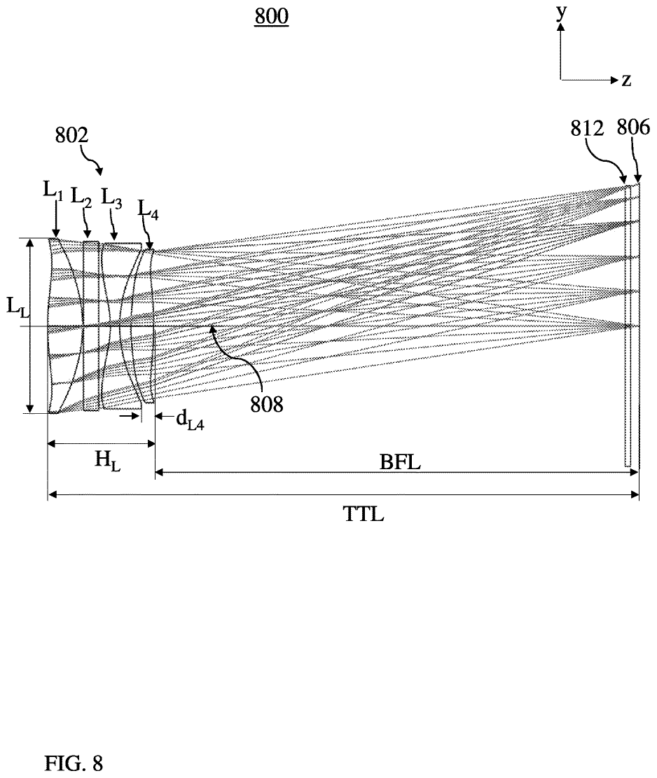

FIG. 8 shows another example of an optical lens system disclosed herein and numbered 800. Optical lens system 800 includes a hybrid lens. Here, L₂ is a metalens element. The substrate height is H_{Substrate}=0.6 mm. Optical lens system 800 comprises a lens 802 with a plurality of N=4 lens elements numbered L₁-L₄, an image sensor 806 and an (optional) optical element 812. Optical lens system 800 may further comprise an OPFE (not shown) that folds a first OP1 to a second OP2 (not shown). A lens optical axis 808 of lens 802 may be oriented parallel to OP1. The OPFE forms an angle of 45 degrees with both the y-axis and the z-axis. G₁=0.02 mm and is located at optical axis 808. L₄ expands over a relatively low distance (“d_{L4}”). d_{L4}=0.49 mm and a ratio d_{L4}/H_{L}=0.12.

Surface types are defined in Table 21. The coefficients for the surfaces of the regular lens elements (L₁, L₃, L₄) are defined in Table 22. Phase coefficients of the metalens element (L₂) are defined in Table 23.

TABLE 21

| | | | | | Aperture | | | | |
|---|---|---|---|---|---|---|---|---|---|
| | | | Curvature | | Radius | | | | Focal |
| Surface # | Comment | Type | Radius | Thickness | (D/2) | Material | Index | Abbe # | Length |
| 1 | A.S. | Plano | Infinity | −1.37E−04 | 3.375 | | | | |
| 2 | Lens 1 | ASP | 10.186 | 1.377 | 3.375 | Plastic | 1.54 | 55.9 | 6.304 |
| 3 | | ASP | −4.952 | 0.020 | 3.395 | | | | |
| 4 | Lens 2 | Bin2 | Infinity | 0.600 | 3.284 | Glass | 1.46 | 67.8 | 424.694 |
| 5 | | Plano | Infinity | 0.463 | 3.239 | | | | |
| 6 | Lens 3 | ASP | −3.772 | 0.366 | 3.222 | Plastic | 1.59 | 28.4 | −3.420 |
| 7 | | ASP | 4.514 | 0.441 | 2.972 | | | | |
| 8 | Lens 4 | ASP | 7.464 | 0.892 | 2.984 | Plastic | 1.64 | 23.5 | 7.380 |
| 9 | | ASP | −12.469 | 18.501 | 2.940 | | | | |
| 10 | Filter | Plano | Infinity | 0.210 | — | Glass | 1.52 | 64.2 | |
| 11 | | | Infinity | 0.350 | — | | | | |
| 12 | Image | Plano | Infinity | — | — | | | | |

TABLE 22

| | Aspheric Coefficients | | | |
|---|---|---|---|---|
| Surface # | Conic | 4^{th} | 6^{th} | 8^{th} |
| 2 | 0 | −2.42E−03 | −2.79E−04 | 1.72E−05 |
| 3 | 0 | 5.18E−03 | −1.07E−04 | −4.79E−05 |
| 6 | 0 | 2.21E−02 | −5.26E−04 | −3.17E−04 |
| 7 | 0 | −1.43E−02 | 5.27E−03 | −1.04E−03 |
| 8 | 0 | −1.13E−02 | 1.31E−03 | 1.62E−04 |
| 9 | 0 | 2.62E−03 | −4.18E−04 | 9.10E−05 |

| | Aspheric Coefficients | | | |
|---|---|---|---|---|
| Surface # | 10^{th} | 12^{th} | 14^{th} | 16^{th} |
| 2 | 1.59E−06 | −7.10E−07 | 6.47E−08 | −1.60E−09 |
| 3 | 6.75E−06 | −5.03E−07 | 1.89E−08 | 5.50E−11 |
| 6 | 5.88E−05 | −4.03E−06 | 1.10E−07 | −2.83E−10 |
| 7 | 1.27E−04 | −1.25E−05 | 8.03E−07 | −1.99E−08 |
| 8 | −2.82E−06 | −7.50E−06 | 8.61E−07 | −2.64E−08 |
| 9 | 1.37E−05 | −2.69E−06 | 7.24E−08 | 3.76E−09 |

TABLE 23

| | Phase Coefficients | | | | |
|---|---|---|---|---|---|
| Surface # | Norm Radius | p² | p⁴ | p⁶ | p⁸ |
| 4 | 3.284 | −143.729 | 1653.854 | −8396.682 | 23951.155 |

| | Phase Coefficients | | | |
|---|---|---|---|---|
| Surface # | p¹⁰ | p¹² | p¹⁴ | p¹⁶ |
| 4 | −42174.274 | 44150.646 | −24867.829 | 5749.582 |

In some examples, a regular or hybrid lens such as 202, 252, 302, 402, 502, 602, 702 or 802 may be a cut lens as known in the art. With reference to FIG. 1A and FIG. 1C, one or more lens elements may be cut along a direction parallel to the y-axis, so that a lens length LL of a cut lens element measured along the z-direction (“L_{L}”) is smaller than in a lens width (“W_{L}”) measured along a x-direction, i.e. L_{L}<W_{L}. Lens length L_{L} may be cut by about 20%-50%, i.e. a L_{L} may be smaller than W_{L} by about 20%-50%. The cutting of the lens translates to significant savings in terms of H_{M}, which is beneficial for slim mobile device design. The cutting of a lens by 20% may translate into savings in terms of H_{M} of about 10-20%.

It is appreciated that certain features of the presently disclosed subject matter, which are, for clarity, described in the context of separate examples, may also be provided in combination in a single example. Conversely, various features of the presently disclosed subject matter, which are, for brevity, described in the context of a single example, may also be provided separately or in any suitable sub-combination.

Unless otherwise stated, the use of the expression “and/or” between the last two members of a list of options for selection indicates that a selection of one or more of the listed options is appropriate and may be made.

It should be understood that where the claims or specification refer to “a” or “an” element, such reference is not to be construed as there being only one of that element.

All patents and patent applications mentioned in this specification are herein incorporated in their entirety by reference into the specification, to the same extent as if each individual patent or patent application was specifically and individually indicated to be incorporated herein by reference. In addition, citation or identification of any reference in this application shall not be construed as an admission that such reference is available as prior art to the present disclosure.

What is claimed is:

1. A camera, comprising:
a lens with a plurality of N lens elements Lᵢ wherein 1≤i≤N arranged along a lens optical axis OA and an effective focal length EFL, wherein a first lens element L₁ faces an object side and a last lens element L_{N} faces an image side;
an image sensor; and
an optical path folding element OPFE for folding a first optical path OP1 to a second optical path OP2 that is perpendicular to the image sensor,
wherein the lens comprises a metalens element and two or more refractive lens elements, and wherein all refractive lens elements are located at an object side of the OPFE.

2. The camera of claim 1, wherein the metalens element is a single metalens element, and wherein a focal length of the single metalens element f_{M} fulfills f_{M}/EFL >7.5.

3. The camera of claim 2, wherein f_{M}/EFL <100.

4. The camera of claim 2, wherein 10<f_{M}/EFL <50.

5. The camera of claim 1, wherein the metalens element has a focal length f_{M}, and wherein 100 mm<f_{M}<1500 mm.

6. The camera of claim 5, wherein f_{M} is in the range 200 mm<f_{M}<1000 mm.

7. The camera of claim 1, wherein the metalens element is a single metalens element, and wherein the single metalens element is L₂ or L₄.

8. The camera of claim 1, wherein the lens comprises two metalens elements, wherein a first metalens element that is closer to an object side has a first focal length f_{M1} and a second metalens element that is closer to an image side has a second focal length f_{M2}, and wherein both f_{M1} and f_{M2} are positive.

9. The camera of claim 8, wherein f_{M1}/EFL>7.5 and f_{M2}/EFL>7.5.

10. The camera of claim 8, wherein f_{M1}/EFL<100 and f_{M2}/EFL<100.

11. The camera of claim 8, wherein both f_{M1} and f_{M2} are in the range 100 mm<f_{M1}, f_{M2}<1500 mm.

12. The camera of claim 1, wherein the lens is located at an object side of the OPFE.

13. The camera of claim 1, wherein 10 mm<EFL<27.5 mm.

14. The camera of claim 1, wherein the image sensor has a full sensor diagonal SD, and wherein 0.3<SD/EFL <0.7.

15. The camera of claim 1, wherein N ≥4.

16. The camera of claim 1, wherein the lens has an f-number f/#<3.75.

17. The camera of claim 1, wherein the OPFE is oriented at an angle β with respect to the OA, and wherein β>45 degrees.

18. The camera of claim 1, wherein the camera is included in a camera module, wherein the camera module has a module region having a module region height H_{M} measured along OP1 and a shoulder region having a shoulder region height H_{S} measured along OP1, and wherein H_{M}>H_{S}.

19. A mobile device including the camera of claim 18, wherein the mobile device has a device thickness T and a camera bump, wherein the bump region has an elevated height T+B along OP1, wherein the first module region is incorporated into the camera bump region and at least parts of the second shoulder region is not incorporated into the camera bump.

20. The camera of claim 1, wherein the camera is included in a smartphone.
